(19) United States
(12) Patent Application Publication
(10) Pub. No.: US 2025/0350953 A1
(43) Pub. Date: Nov. 13, 2025

(54) COMMUNICATION CONTROL APPARATUS, RADIO SYSTEM, AND RADIO RESOURCE ALLOCATION METHOD

(71) Applicant: Fujitsu Limited, Kawasaki-shi (JP)

(72) Inventor: Takaharu KOBAYASHI, Yamato (JP)

(73) Assignee: Fujitsu Limited, Kawasaki-shi (JP)

(21) Appl. No.: 19/276,125

(22) Filed: Jul. 22, 2025

Related U.S. Application Data
(63) Continuation of application No. PCT/JP2023/045651, filed on Dec. 20, 2023.

(30) Foreign Application Priority Data
Feb. 6, 2023 (JP) 2023-016225

(51) Int. Cl. H04W 16/10

(52) U.S. Cl. CPC H04W 16/10

(57) ABSTRACT

A communication control apparatus that manages a plurality of radio apparatuses allocated for each cluster and shared by a plurality of operators includes: a controller that allocates a radio resource of each operator for each radio apparatus in each cluster in accordance with a constraint condition decided; a calculator that calculates an alteration-induced value related to an evaluation value for each operator of each radio apparatus in each cluster under an assumption of increasing/decreasing a radio resource allocated to each operator of each radio apparatus in the cluster; and decision processor circuitry that decides, for each cluster, a constraint condition that maximizes the alteration-induced value of each radio apparatus in all the clusters and under which a capacity of a radio resource allocated to each radio apparatus satisfies a first prescribed quantity and a calculation capacity satisfies a second prescribed quantity.

### CROSS-REFERENCE TO RELATED APPLICATION(S)

This application is a continuation application of International Application No. PCT/JP2023/045651, filed on Dec. 20, 2023 which claims the benefit of priority of the prior Japanese Patent Application No. 2023-016225, filed on Feb. 6, 2023, the entire contents of each are incorporated herein by reference.

### FIELD

The embodiments discussed herein are related to a communication control apparatus, a radio system, and a radio resource allocation method.

### BACKGROUND

In recent years, services using fifth generation mobile communication (5G) capable of high-speed and large-capacity data communication have been introduced in radio systems. The service using 5G utilizes, for example, a radio wave, such as a millimeter wave, having a higher frequency than in services such as Long Term Evolution (LTE). Such a high frequency radio wave has high straightness and is difficult to transmit through a shielding object, and thus its cell radius tends to be small. As a result, construction of the radio system requests installation of the base station apparatuses at high density.

Specifically, the base station apparatus is separated into a baseband apparatus (Central Unit/Distributed Unit: CU/DU) that performs baseband processing and a radio apparatus (Radio Unit: RU) that performs radio processing, for example, and thus, RUs having antennas are to be located at high density. Therefore, a Mobile Network Operator (MNO), being an operator constructing a radio system, can expand a communication area and a system capacity by installing an RU that can be cooperatively shared with other MNOs.
Patent Document 1: Japanese National Publication of International Patent Application No. 2019-526954
Patent Document 2: Japanese National Publication of International Patent Application No. 2013-511935
Patent Document 3: Japanese Laid-open Patent Publication No. 2022-102536

Meanwhile, as a method of installing the RU shared by a plurality of MNOs (hereinafter referred to as a “shared RU”), it is conceivable to replace a dedicated RU already installed for each MNO with a shared RU. As a result, the CU/DU of each MNO is to be connected to a large number of shared RUs as compared with the case of being connected to the dedicated RU. Furthermore, a front haul (FH) line connecting the CU/DU and the shared RU to each other is to be shared by a plurality of MNOs.

### SUMMARY

According to an aspect of the embodiments, a communication control apparatus manages a plurality of radio apparatuses allocated for each cluster and shared by a plurality of operators, the communication control apparatus including: a control unit that allocates a radio resource of each operator for each radio apparatus in each cluster in accordance with a constraint condition decided; a calculation unit that calculates an alteration-induced value related to an evaluation value for each operator of each radio apparatus in each cluster under an assumption of increasing/decreasing a radio resource allocated to each operator of each radio apparatus in the cluster; and a decision unit that decides, for each cluster, a constraint condition that maximizes the alteration-induced value of each radio apparatus in all the clusters and under which a capacity of a radio resource allocated to each radio apparatus satisfies a first prescribed quantity and a calculation capacity of a radio resource allocated to each operator in an entire cluster satisfies a second prescribed quantity.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is an explanatory diagram illustrating an example of a configuration of a radio system according to a first exemplary embodiment;

FIG. 2 is an explanatory diagram illustrating an example of a cluster configuration;

FIG. 3 is an explanatory diagram illustrating an example of a band allocation list;

FIG. 4 is a block diagram illustrating an example of a first communication control apparatus;

FIG. 5 is an explanatory diagram illustrating an example of an intra-cluster allocation table;

FIG. 6 is an explanatory diagram illustrating an example of an intra-cluster evaluation table;

FIG. 7 is a block diagram illustrating an example of a second communication control apparatus;

FIG. 8 is an explanatory diagram illustrating an example of an allocation table;

FIG. 9 is an explanatory diagram illustrating an example of an evaluation table;

FIG. 10 is an explanatory diagram illustrating an example of an evaluation result table;

FIG. 11 is a sequence diagram illustrating an example of a band allocation method according to the first exemplary embodiment;

FIG. 12 is a flowchart illustrating an example of a processing operation of the first communication control apparatus related to first calculation processing;

FIG. 13 is a flowchart illustrating an example of a processing operation of the first communication control apparatus related to second calculation processing;

FIG. 14 is a flowchart illustrating an example of a processing operation of the second communication control apparatus related to adjustment processing;

FIG. 15 is a flowchart illustrating an example of a processing operation of the first communication control apparatus related to setting processing;

FIG. 16 is a flowchart illustrating an example of a processing operation of the first communication control apparatus related to setting processing;

FIG. 17 is an explanatory diagram illustrating an example of an evaluation table before and after execution of the setting processing;

FIG. 18 is an explanatory diagram illustrating time to be used for optimization according to the number of RUs in a cluster;

FIG. 19 is an explanatory diagram illustrating an example of a configuration of a radio system according to a second exemplary embodiment;

FIG. 20 is a block diagram illustrating an example of a first communication control apparatus;

FIG. 21 is an explanatory diagram illustrating an example of an intra-first cluster evaluation table;

FIG. 22 is an explanatory diagram illustrating an example of an intra-second cluster evaluation table;

FIG. 23 is a block diagram illustrating an example of a second communication control apparatus;

FIG. 24 is a sequence diagram illustrating an example of a band allocation method according to the second exemplary embodiment;

FIG. 25 is an explanatory diagram illustrating an example of a cluster configuration of a radio system of a comparative example; and

FIG. 26 is an explanatory diagram illustrating an example of a band allocation list.

### DESCRIPTION OF EMBODIMENTS

However, even when replacing the dedicated RU with the shared RU, it is difficult to further reinforce and add the CU/DU and the FH line of each MNO. Additionally, in a case where each MNO uses the shared RU, there might be a case where the calculation capacity of the CU/DU or the capacity of the FH line will be exceeded. For example, in a case where the use band of the shared RU is increased in accordance with the quantity of MNOs that share the shared RU, the capacities of the CU/DU and the FH line is to preferably follow the increase in the use band, leading to limitation of the expansion of the system capacity. That is, there is a demand for a radio system to enable expansion of the system capacity while increasing/decreasing radio resources such as a use band.

The present applicants propose a communication control apparatus that is connected to a plurality of CUs/DUs managed by a plurality of MNOs and allocates a use band in a plurality of RUs shared by the plurality of MNOs to the plurality of MNOs. The communication control apparatus aggregates Reference Signal Received Power (RSRP: representing reception quality information) information between the UE and the RU, and decides, based on the RSRP information, a use band quantity to be allocated to each RU of each MNO so as to satisfy a FH capacity constraint condition and a DU calculation resource constraint condition.

The FH capacity constraint condition is a constraint condition for preventing the capacity of each RU from exceeding a predetermined FH capacity. The DU calculation resource constraint condition is a constraint condition for setting a calculation capacity, which is an allocation quantity of a predetermined use band of each MNO in the entire radio system, to a prescribed quantity.

As a result, based on the RSRP information, the communication control apparatus decides the allocation quantity of use bands to be allocated to each RU of each MNO so as to satisfy the FH capacity constraint condition and the DU calculation resource constraint condition. That is, for example, even when the allocation quantity of the use band of the RU is increased in accordance with the quantity of MNOs sharing the RU, the system capacity can be expanded by causing the CU/DU and the FH line capacities to follow the increase in the allocation quantity of the use band.

However, in the radio system, when the number of RUs shared by the plurality of MNOs increases, the computation amount for optimizing the use band of each MNO for each RU becomes enormous. Therefore, it is conceivable to perform clustering of a plurality of RUs to distribute the computation amount in units of clusters.

### COMPARATIVE EXAMPLE

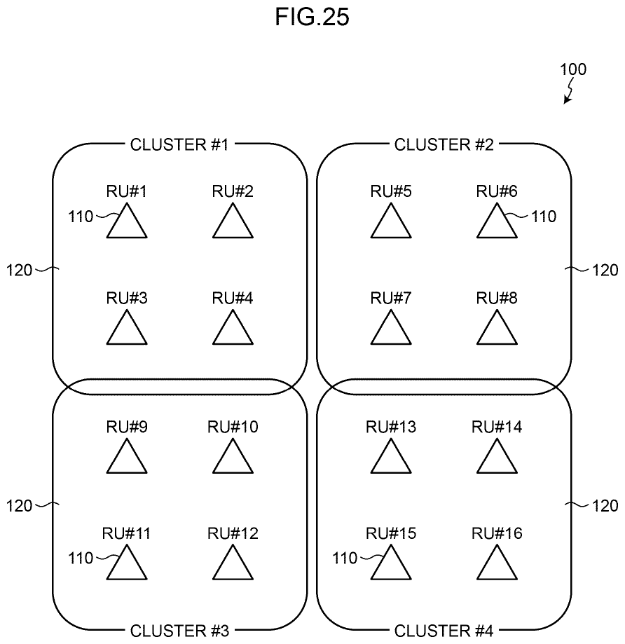

FIG. 25 is an explanatory diagram illustrating an example of a cluster configuration of radio system 100 according to a comparative example. For convenience of description, the radio system 100 has a cluster configuration in which the number of RU 110 in the entire system is sixteen, namely, RU 110 #1 to #16, and number of clusters 120 is four, namely, clusters #1 to #4. The RU 110 #1 to #16 are to be RUs shared by a plurality of MNOs. The cluster 120 #1 illustrated in FIG. 25 includes four RU 110, namely, RU 110 #1 to #4, and the cluster 120 #2 includes four RU 110, namely, RU 110 #5 to #8. Furthermore, the cluster 120 #3 includes four RU 110, namely, RU 110 #9 to #12, and the cluster 120 #4 includes four RU 110, namely, RU 110 #13 to #16.

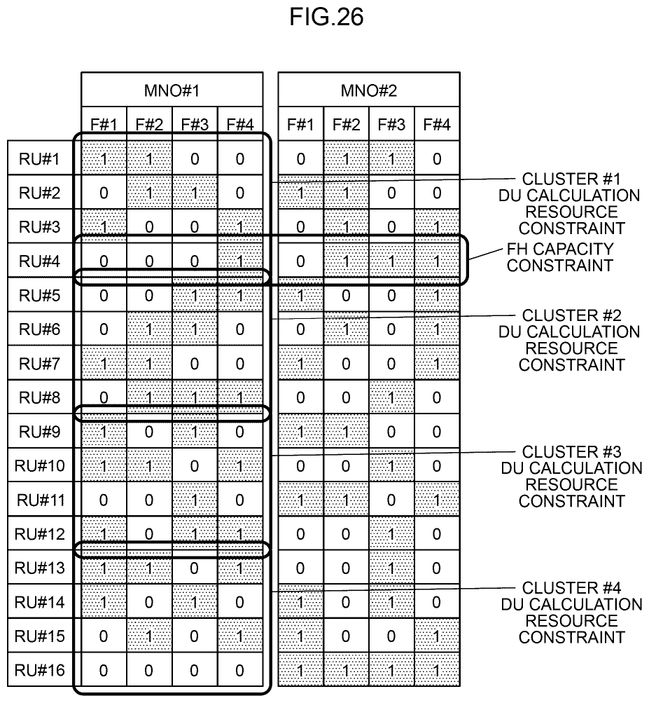

FIG. 26 is an explanatory diagram illustrating an example of band allocation list. The band allocation list includes information indicating the presence or absence of a use band to be allocated to each MNO for each RU 110. The use bands are use bands F #1 to F #4 of four different frequencies, for example, used by the RU 110 for radio communication with a UE. The RU 110 is to be shared by the MNO #1 and #2. The DU calculation resource constraint condition is a condition for constraining the allocation quantity of use bands to be allocated to each MNO in the cluster. For example, in the DU calculation resource of the cluster 120 #1, the allocation quantity of the use band of the MNO #1 is seven, and the allocation quantity of the use band of the MNO #2 is nine. The FH capacity constraint condition is a condition for constraining the allocation quantity of use bands in which the flow rate for each RU 110 is a prescribed quantity. For example, in the FH capacity constraint condition of the RU 110, the allocation quantity of the use band of the RU 110 shared by the MNO #1 and #2 is set to 4. Note that the allocation quantity of use bands is one unit.

The band allocation list manages, for each RU 110, setting of busy “1” and disabled “₀” indicating the presence or absence of use bands F #1 to F #4. For example, when focusing on the RU 110 #1 in the cluster 120 #1, the setting of the RU 110 #1 in the MNO #1 indicates busy “1” for the use bands of F1 # and F #2 and disabled “0” for the use bands of F3 # and F #4. That is, the allocation quantity of the use bands of the MNO #1 of the RU 110 #1 is two. The setting of the RU 110 #1 in the MNO #2 indicates busy “1” for the use bands of F2 # and F #3 and disabled “0” for the use bands of F1 # and F #4. That is, the allocation quantity of the use bands of the MNO #2 of the RU 110 #1 is two.

For example, when focusing on the RU 110 #9 in the cluster #3, the setting of the RU 110 #9 in the MNO #1 indicates busy “1” for the use bands of F #1 and F #3 and disabled “0” for the use bands of F #2 and F #4. That is, the allocation quantity of the use bands of the MNO #1 of the RU 110 #9 is two. The setting of the RU 110 #9 in the MNO #2 indicates busy “1” for the use bands of F #1 and F #2 and disabled “0” for the use bands of F #3 and F #4. That is, the allocation quantity of the use bands of the MNO #2 of the RU 110 #9 is two.

As illustrated in FIG. 26, in a case where the plurality of RU 110 is divided in units of clusters, it is preferable to satisfy the DU calculation resource constraint condition and the FH capacity constraint condition in units of clusters, and thus, the constraint condition becomes strict.

In the radio system 100, the constraint condition of the use band to be allocated to each MNO for each RU 110 in the cluster is fixed for each cluster so as to satisfy the DU calculation resource constraint condition and the FH capacity constraint condition. In the radio system 100, when unevenness occurs in the number of UEs for each MNO in the cluster, for example, it would be preferable to alter the allocation quantity of the use bands between the clusters in consideration of the load balance for each MNO in the cluster. For example, when the number of UEs of the MNO #1 increases in the cluster #1, the allocation quantity of use bands to be allocated to the MNO #1 of each RU 110 of the cluster #1 is increased so as to decrease the allocation quantity of use bands to be allocated to the MNO #2. In addition, for example, it is conceivable to increase the allocation quantity of use bands to be allocated to the MNO #2 of each RU 110 of the cluster #3 having small number of UEs of the MNO #1 to decrease the allocation quantity of use bands to be allocated to the MNO #1. However, the allocation quantity of the use band of each MNO for each RU 110 for each cluster is fixed, making it difficult to adjust the allocation quantity of the use band to be allocated to each MNO of each RU 110 in the cluster between clusters in accordance with the load.

In view of this, the present applicant will describe an embodiment capable of adjusting the allocation quantity of the use band to be allocated to each MNO of each RU 110 in the cluster in accordance with the load among the clusters while satisfying the DU calculation resource constraint condition and the FH capacity constraint condition, as a first exemplary embodiment.

### First Exemplary Embodiment

Hereinafter, an embodiment of a communication control apparatus or the like disclosed in the present application will be described in detail with reference to the drawings. The present disclosed technique is not limited to the present exemplary embodiments. Moreover, it is possible to combine each of the exemplary embodiments described below appropriately in a scope that would not conflict with each other.

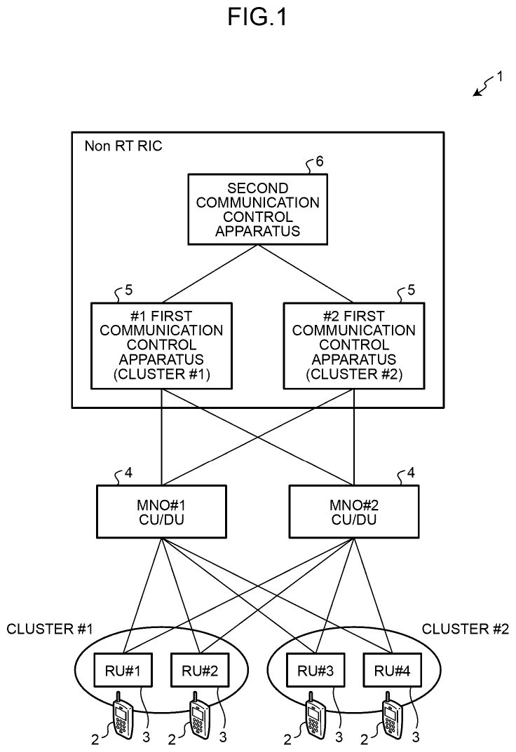

FIG. 1 is an explanatory diagram illustrating an example of a configuration of a radio system 1 according to the first exemplary embodiment. The radio system 1 illustrated in FIG. 1 includes a plurality of user equipment (UE) 2, a plurality of radio units (RUs) 3, a plurality of central units/distributed units (CU/DU) 4, a plurality of first communication control apparatuses 5, and a second communication control apparatus 6. The plurality of UE 2 is provided for each Mobile Network Operator (MNO), and is a terminal apparatus such as a smartphone or a tablet that performs radio communication with the RU 3. The UE 2 performs radio communication with the RU 3 forming a cell in which the UE 2 resides. The UE 20 is managed by one MNO among a plurality of MNOs sharing the RU 3, and transmits and receives data to and from the CU/DU 4 of the MNO.

The plurality of RU 3 is, for example, radio apparatuses shared by different MNOs. An example of the plurality of RU 3 is RU 3 #1 to #4 divided for each cluster. The cluster includes, for example, a cluster #1 and a cluster #2 different from the cluster #1. The RU 3 in the cluster #1 has a RU 3 #1 and a RU 3 #2. RU 3 in the cluster #2 has RU 3 #3 and RU 3 #4.

The CU/DU 4 is a baseband apparatus provided for each MNO to constitute a base station. The CU/DU 4 #1 is the CU/DU of the MNO #1 connected to the RU 3 #1 to #4 in the clusters #1 and #2 and connected to the first communication control apparatuses 5 #1 and #2. The CU/DU 4 #2 is the CU/DU of the MNO #2 connected to the RU 3 #1 to #4 in the clusters #1 and #2 and connected to the first communication control apparatuses 5 #1 and #2.

The first communication control apparatus 5 is an individual communication control apparatus that manages the RU 3 for each cluster. The first communication control apparatus 5 includes, for example, the first communication control apparatus 5 #1 and the first communication control apparatus 5 #2. The first communication control apparatus 5 #1 is connected to the CU/DU 4 #1 and #2 and manages the RU 3 #1 and #2 in the cluster #1. The first communication control apparatus 5 #2 is connected to the CU/DU 4 #1 and #2 and manages the RU 3 #3 and #4 in the cluster #2.

The second communication control apparatus 6 is a common communication control apparatus that is connected to the first communication control apparatuses 5 #1 and #2 and manages the RU 3 #1 to #4 in all clusters in the radio system 1. The second communication control apparatus 6 manages the use band to be allocated to each MNO of each RU 3 across a plurality of MNOs in a cluster or between clusters. Note that the first communication control apparatus 5 and the second communication control apparatus 6 include Non-realtime RIC (Non-RT RIC), for example.

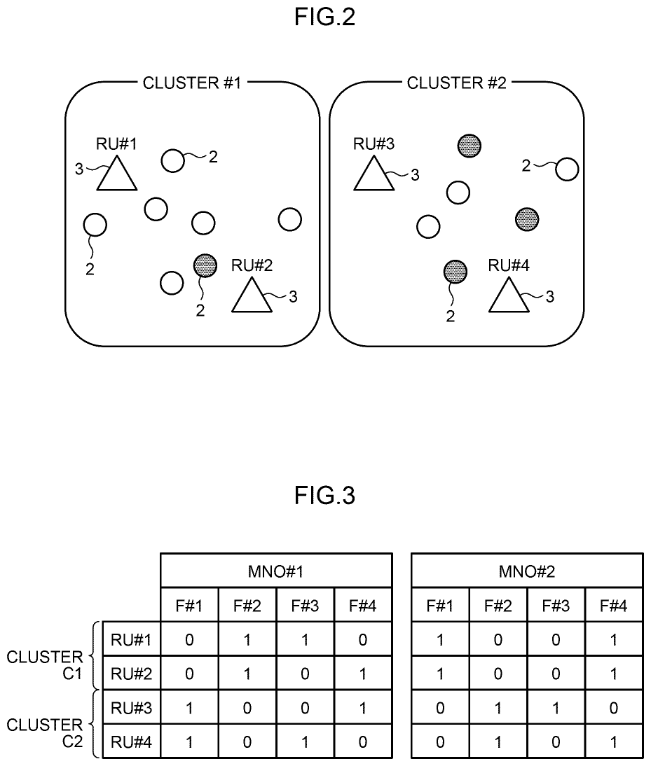

FIG. 2 is an explanatory diagram illustrating an example of a cluster configuration. The cluster #1 illustrated in FIG. 2 includes RU 3 #1 and #2, and has UE 2 of the MNO #1 and UE 2 of the MNO #2 mixed with each other. The cluster #2 includes RU 3 #3 and #4, and has UE 2 of the MNO #1 and UE 2 of the MNO #2 mixed each other.

FIG. 3 is an explanatory diagram illustrating an example of a band allocation list. The band allocation list illustrated in FIG. 3 manages the presence or absence of allocation of the use bands F #1 to F #4 to be allocated to the MNO #1 and #2 for each RU 3 #1 and #2 in the cluster #1. The band allocation list manages, for each RU 3, setting of busy “1” and disabled “0” indicating the presence or absence of use bands F #1 to F #4. For example, when focusing on the RU 3 #1, the MNO #1 has a setting in which the use bands of F #2 and F #3 are busy “1” and use bands of F #1 and F #4 are disabled “0”. That is, the allocation quantity of the use bands of the MNO #1 of the RU 3 #1 is 2. In the MNO #2, the use bands of F #1 and F #4 are busy “1”, and the use bands of F #2 and F #3 are disabled “0”. That is, the allocation quantity of the use band of the MNO #2 of the RU 3 #1 is two.

The band allocation list illustrated manages the presence or absence of allocation of the use bands F #1 to F #4 to be allocated to the MNO #1 and #2 for each RU 3 #3 and #4 in the cluster #2. For example, when focusing on the RU 3 #4, the MNO #1 has a setting in which the use bands of F #2 and F #3 are busy “1” and use bands of F #1 and F #4 are disabled “0”. That is, the allocation quantity of the use bands of the MNO #1 of the RU 3 #4 is 2. In the MNO #2, the use bands of F #1 and F #4 are busy “1”, and the use bands of F #2 and F #3 are disabled “0”. That is, the allocation quantity of the use bands of the MNO #2 of the RU 3 #4 is two. That is, the band allocation list is an allocation list of the use bands to be allocated to each MNO for each RU 3, satisfying the FH capacity constraint requirement and the DU calculation resource constraint requirement.

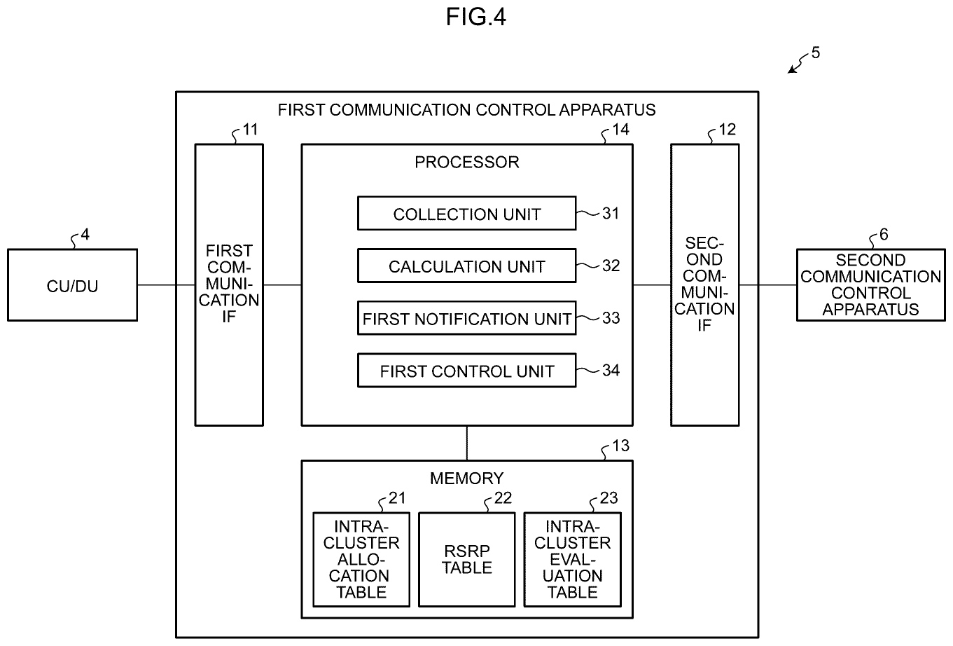

FIG. 4 is a block diagram illustrating an example of the first communication control apparatus 5. The first communication control apparatus 5 illustrated in FIG. 4 includes a first communication interface (IF) 11, a second communication IF 12, memory 13, and a processor 14. The first communication IF 11 is a communication IF connected to the CU/DU 4 #1 and #2. The second communication IF 12 is a communication IF connected to the second communication control apparatus 6. The memory 13 stores various types of information. The memory 13 includes Random Access Memory (RAN) or Read Only Memory (ROM), and stores information used for the processing performed by the processor 14. The memory 13 includes an intra-cluster allocation table 21, an RSRP table 22, and an intra-cluster evaluation table 23.

The processor 14 includes, for example, a Central Processing Unit (CPU), a Field Programmable Gate Array (FPGA), a Digital Signal Processor (DSP), or the like, and integrally controls the entire first communication control apparatus 5. The RSRP table 22 collects RSRP information between the RU 3 and the UE 2 in the clusters #1 and #2 from the first communication control apparatus 5 in the cluster #1 and the first communication control apparatus 5 in the cluster #2, and stores the collected RSRP information. Here, since the UE 2 measures the reception quality not only for the RU 3 of the radio communication partner but also for all the RU 3 in a reference signal reception range, the RSRP information of one UE 2 includes the reception quality from each of the plurality of RU 3.

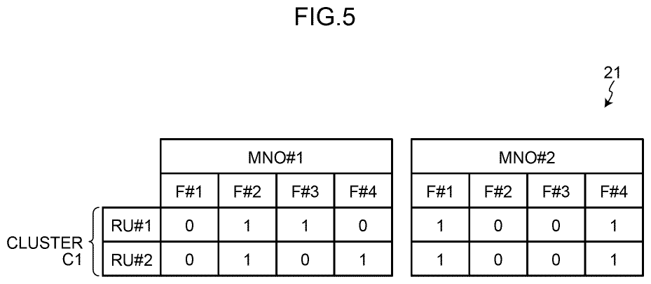

FIG. 5 is an explanatory diagram illustrating an example of the intra-cluster allocation table 21. The intra-cluster allocation table 21 is a table that manages the presence or absence of allocation of the use band to be allocated to each MNO for each RU 3 in an own cluster. For convenience of description, the intra-cluster allocation table 21 illustrated in FIG. 5 is a table included in the first communication control apparatus 5 #1 that manages the cluster #1. The first communication control apparatus 5 refers to the intra-cluster allocation table 21 and sets the use band of each MNO for each of the RU 3 #1 and #2 in the cluster #1.

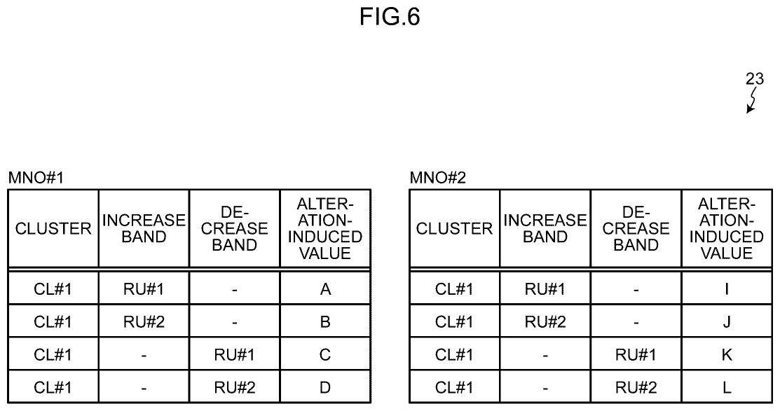

FIG. 6 is an explanatory diagram illustrating an example of the intra-cluster evaluation table 23. The intra-cluster evaluation table 23 illustrated in FIG. 6 is a table that manages an alteration-induced value according to the band increase/decrease of each RU 3 for each MNO in the own cluster. For convenience of description, the intra-cluster evaluation table 23 illustrated in FIG. 6 is a table included in the first communication control apparatus 5 #1 that manages the cluster #1. The intra-cluster evaluation table 23 of the MNO #1 manages an alteration-induced value A of the KPI created at a single increase of the allocation quantity of the use band of the RU 3 #1 in the cluster #1, and manages an alteration-induced value B of the KPI created at a single increase of the allocation quantity of the use band of the RU 3 #2 in the cluster #1. The intra-cluster evaluation table 23 of the MNO #1 manages an alteration-induced value C of the KPI created at a single decrease of the allocation quantity of the use band of the RU 3 #1 in the cluster #1, and manages an alteration-induced value D of the KPI created at a single decrease of the allocation quantity of the use band of the RU 3 #2 in the cluster #1. Note that KPI is an influence evaluation value.

The intra-cluster evaluation table 23 of the MNO #2 manages an alteration-induced value I of the KPI created at a single increase of the allocation quantity of the use band of the RU 3 #1 in the cluster #1, and manages an alteration-induced value J of the KPI created at a single increase of the allocation quantity of the use band of the RU 3 #2 in the cluster #1. The intra-cluster evaluation table 23 of the MNO #2 manages an alteration-induced value K of the KPI created at a single decrease of the allocation quantity of the use band of the RU 3 #1 in the cluster #1, and manages an alteration-induced value L of the KPI created at a single decrease of the allocation quantity of the use band of the RU 3 #2 in the cluster #1.

The processor 14 includes, as functions, a collection unit 31, a calculation unit 32, a first notification unit 33, and a first control unit 34. The collection unit 31 collects, from each RU 3, RSRP information of the UE 2 that performs radio communication with the RU 3, and stores the collected RSRP information in the RSRP table 22. Based on the collected RSRP information, the calculation unit 32 calculates an alteration-induced value according to the increase/decrease value of the KPI predicted when increasing the allocation quantity of the use band to be allocated to each MNO for each RU 3 in the own cluster. The calculation unit 32 calculates an alteration-induced value according to the increase/decrease value of the KPI predicted when decreasing the allocation quantity of use bands to be allocated to each MNO for each RU 3 in the own cluster.

Based on the collected RSRP information, the calculation unit 32 calculates the KPI predicted when increasing the allocation quantity of the use band to be allocated to each MNO for each RU 3 in the own cluster. The calculation unit 32 calculates the KPI predicted when decreasing the allocation quantity of the use band to be allocated to each MNO for each RU 3 in the own cluster. The calculation unit 32 calculates the increase/decrease value of KPI based on a difference between an initial KPI and the calculated KPI. Furthermore, the calculation unit 32 calculates an alteration-induced value according to the increase/decrease value of KPI, and updates and registers the calculated alteration-induced value in the intra-cluster evaluation table 23.

Based on the collected RSRP information, the calculation unit 32 can express the received power value with each UE 2 for each RU 3 in the cluster by (Mathematical Expression 1).

$${s}_{u} = {argmax}_{s} ( {P}_{u , s} ) \qquad ( 1 )$$

$${P}_{u , s} : RECEIVED POWER VALUE FROM RU \# s IN UE \# u$$

The calculation unit 32 calculates the reception SINR of the use band #f by (Mathematic Expression 2).

$${γ}_{u , f} = \frac{{o}_{s , f} {P}_{u , {s}_{u}}}{{P}_{n} + {\sum }_{{s ∈ {S}_{{s}_{u}}}_{s \neq {s}_{u}}} {P}_{u , s}} \qquad ( 2 )$$

$${o}_{s , f} : PRESENCE OR ABSENCE OF ALLOCATION ( 0 or 1 ) OF RU \# s USE BAND \# f$$

$${P}_{n} : NOISE POWER$$

$${S}_{{s}_{u}} : SET OF RUs BELONGING TO SAME CLUSTER AS RU \# {s}_{u}$$

The calculation unit 32 calculates the throughput of the UE 2 in (Mathematic Expression 3) using the reception SINR of the use band #f.

$${t}_{u} = \frac{1}{\vert {U}_{{s}_{u}} \vert} {\sum }_{f = 0}^{{N}_{f}} B {log}_{2} ( 1 + {γ}_{u , f} ) \qquad ( 3 )$$

$${N}_{f} : NUMBER OF DIVISIONS OF USE BAND$$

$$B : BANDWIDTH PER USE BAND$$

$${U}_{s} : SET OF UEs CONNECTED TO RU \# s$$

$$\vert {U}_{s} \vert : NUMBER OF UEs CONNECTED TO RU \# s$$

The calculation unit 32 calculates a KPI (PF utility) by (Mathematic Expression 4) using the throughput of the UE 2.

$$U = \frac{1}{{\sum }_{s ∈ {S}_{{s}_{u}}} \vert {U}_{s} \vert} {\sum }_{s ∈ {S}_{{s}_{u}}} {\sum }_{u ∈ {U}_{s}} log ( {t}_{u} ) \qquad ( 4 )$$

When the alteration-induced value has been updated and registered in the intra-cluster evaluation table 23, the first notification unit 33 notifies the second communication control apparatus 6 of the alteration-induced value registered in the intra-cluster evaluation table 23. The first control unit 34 performs overall control of the processor 14. The first control unit 34 allocates the use band to each MNO for each RU 3 in the own cluster in accordance with the constraint condition decided by the second communication control apparatus 6.

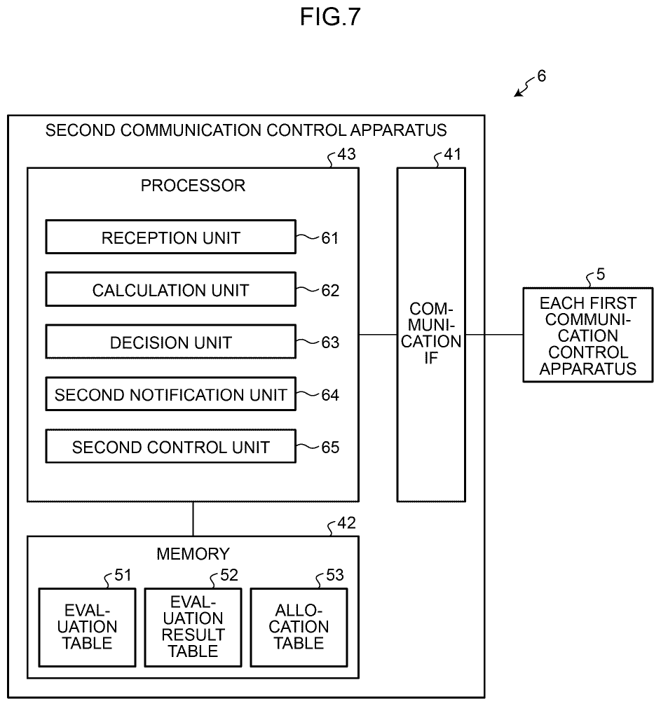

FIG. 7 is a block diagram illustrating an example of the second communication control apparatus 6. The second communication control apparatus 6 illustrated in FIG. 7 includes a communication IF 41, memory 42, and a processor 43. The communication IF 41 is a communication IF connected to each first communication control apparatus 5. The memory 42 stores various types of information. The memory 42 includes, for example, RAM, ROM, or the like, and stores information used for processing performed by the processor 43. The memory 42 includes an evaluation table 51, an evaluation result table 52, and an allocation table 53.

The processor 43 includes, for example, a CPU, an FPGA, a DSP, or the like, and integrally controls the second communication control apparatus 6 as a whole. The processor 43 includes, as functions, a reception unit 61, a calculation unit 62, a decision unit 63, a second notification unit 64, and a second control unit 65. The reception unit 61 receives the alteration-induced value from each first communication control apparatus 5. The calculation unit 62 calculates a constraint condition that maximizes the alteration-induced value of each RU 3 in all clusters. The decision unit 63 decides, for each cluster, a constraint condition that maximizes the alteration-induced value of each RU in all the clusters and under which the capacity of the use band allocated to each RU 3 satisfies a first prescribed quantity and the calculation capacity of the use band allocated to each MNO in the entire cluster satisfies a second prescribed quantity. The second notification unit 64 notifies the first communication control apparatus 5 that manages each cluster of the constraint condition decided for each cluster. The second control unit 65 performs overall control of the processor 43.

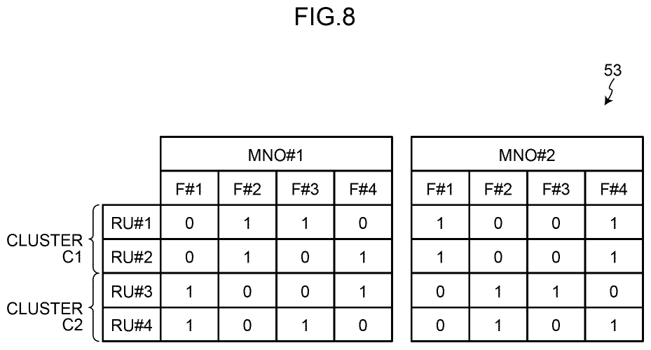

FIG. 8 is an explanatory diagram illustrating an example of the allocation table 53. The allocation table 53 illustrated in FIG. 8 is a table that manages the presence or absence of allocation of the use band of each RU 3 in all clusters for each MNO, as a current allocation list. The processor 43 can recognize the use band of each RU 3 for each MNO of each cluster by referring to the allocation table 53.

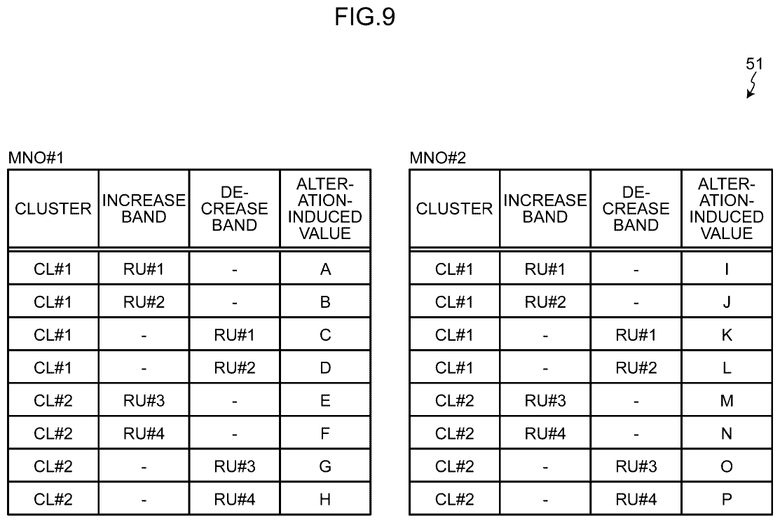

FIG. 9 is an explanatory diagram illustrating an example of the evaluation table 51. The evaluation table 51 illustrated in FIG. 9 is a table that manages an alteration-induced value according to the increase/decrease in the band of each RU 3 in each cluster for each MNO received from each first communication control apparatus 5. The processor 43 can refer to the evaluation table 51 to recognize the alteration-induced value according to the increase/decrease value of the KPI according to the increase/decrease value of the band of each RU 3 for each MNO received from each first communication control apparatus 5.

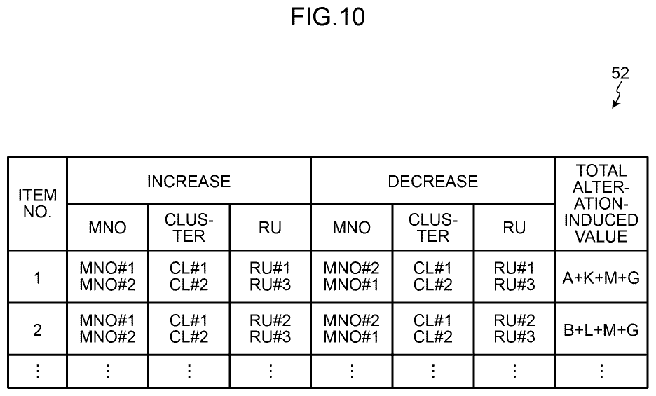

FIG. 10 is an explanatory diagram illustrating an example of the evaluation result table 52. The evaluation result table 52 illustrated in FIG. 10 is a table that stores an evaluation result satisfying the FH capacity constraint condition and the DU calculation resource constraint requirement and maximizing the alteration-induced value. The table manages, as the evaluation result: an item No. for identifying the band allocation list; increase items including an MNO, a cluster, and an RU 3 for increasing the allocation quantity of the use band; decrease items including an MNO, a cluster, and an RU 3 for decreasing the allocation quantity of the use band; and a total alteration-induced value, which are associated with each other.

When focusing on the item No. “1”, the allocation quantity of the use band of the MNO #1 of the RU 3 #1 of the cluster #1 is increased by a predetermined number as an increase item of increasing the use band, while the allocation quantity of the use band of the MNO #2 of the RU 3 #1 of the cluster #1 is decreased by a predetermined number as a decrease item. As a result, the FH capacity constraint requirement is satisfied so that the FH capacity of the RU 3 #1 is a constant capacity. The allocation quantity of the use band of the MNO #2 of the RU 3 #3 of the cluster #2 is increased by a predetermined number, while the allocation quantity of the use band of the MNO #1 of the RU 3 #3 of the cluster #2 is decreased by a predetermined number as a decrease item. As a result, the FH capacity constraint requirement is satisfied so that the FH capacity of the RU 3 #3 is a constant capacity. The predetermined number is “1”, for example.

Furthermore, the allocation quantity of the use band of the MNO #1 of the RU 3 #1 of the cluster #1 is increased by a predetermined number as an increase item, while the allocation quantity of the use band of the MNO #2 of the RU 3 #3 of the cluster #2 is decreased by a predetermined number as a decrease item. As a result, the DU calculation resource constraint requirement of maintaining the allocation quantity of the use bands of the MNO #1 and the MNO #2 as the entire cluster is satisfied. As the increase item, the allocation quantity of the use band of the MNO #2 of the RU 3 #3 in the cluster #2 is increased by a predetermined number, while the allocation quantity of the use band of the MNO #1 of the RU 3 #1 in the cluster #1 is decreased by a predetermined number as the decrease item. As a result, the DU calculation resource constraint requirement of maintaining the allocation quantity of the use bands of the MNO #1 and the MNO #2 as the entire cluster is satisfied.

The processor 43 can refer to the evaluation result table 52 to recognize the evaluation result satisfying the FH capacity constraint condition and the DU calculation resource constraint requirement and maximizing the alteration-induced value.

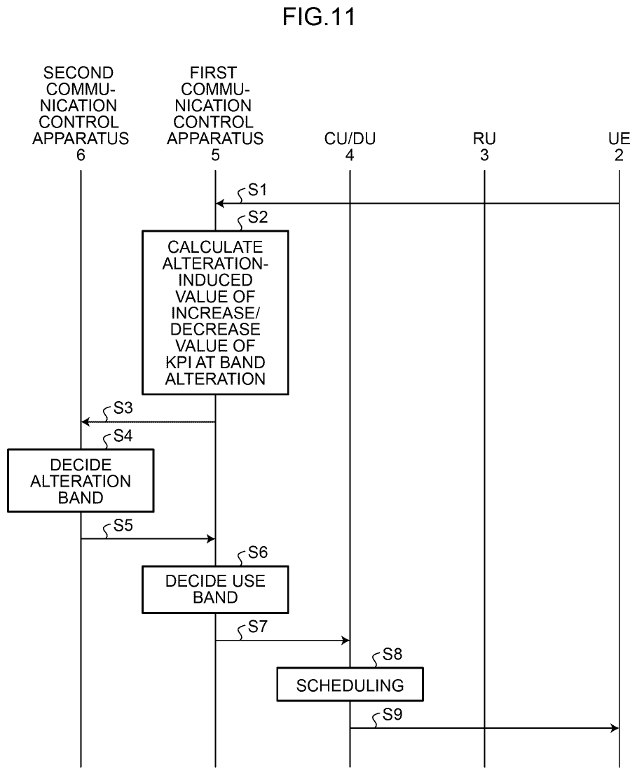

FIG. 11 is a sequence diagram illustrating an example of a band allocation method according to the first exemplary embodiment. The collection unit 31 in the first communication control apparatus 5 collects, through each RU 3 in the own cluster, RSRP information between the RU 3 and the UE 2 connected to each other via radio connection (step S1).

Based on the RSRP information collected from all the UE 2 in the own cluster, the calculation unit 32 in the first communication control apparatus 5 calculates the alteration-induced value according to the increase/decrease value of the KPI when increasing/decreasing the use band of each RU 3 for each MNO (step S2). Specifically, based on the RSRP information, the calculation unit 32 calculates a KPI when having increased the allocation quantity of use bands of each RU 3 for each MNO, and calculates an alteration-induced value according to an increase/decrease value which is a difference between the calculated KPI and the initial KPI. In addition, based on the RSRP information, the calculation unit 32 calculates a KPI when having decreased the allocation quantity of use bands of each RU 3 for each MNO, and calculates an alteration-induced value according to an increase/decrease value which is a difference between the calculated KPI and the initial KPI. Subsequently, the first notification unit 33 notifies the second communication control apparatus 6 of information including the alteration-induced value at the time of band alteration for each RU 3 in the own cluster for each MNO (step S3).

The second communication control apparatus 6 receives information including an alteration-induced value at the time of band alteration of each RU 3 for each MNO in the cluster from each first communication control apparatus 5. The decision unit 63 in the second communication control apparatus 6 decides the alteration band maximizing the alteration-induced value based on the alteration-induced value at the time of band alteration of each RU 3 for each MNO in all clusters (step S4). That is, the decision unit 63 decides the use band of each RU 3 for each MNO in all clusters that satisfies the FH capacity constraint requirement and the DU calculation resource constraint requirement, as the alteration band that is the evaluation result. The second communication control apparatus 6 notifies each first communication control apparatus 5 of the alteration band, being the evaluation result decided (step S5).

When having received the alteration band from the second communication control apparatus 6, each first communication control apparatus 5 decides the use band corresponding to each MNO for each RU 3 in the own cluster, as a piece of the allocation list in accordance with the alteration band (step S6). After deciding the use band, each first communication control apparatus 5 notifies the CU/DU 4 of the MNO of the use band (step S7).

Each CU/DU 4 performs scheduling of a use band notified from each first communication control apparatus 5 (step S8). Furthermore, the CU/DU 4 transmits the scheduling result of the use band to each UE 2 in the own cell (step S9). As a result, the UE 2 transmits and receives data to and from the CU/DU 4 based on the scheduling result of the use band.

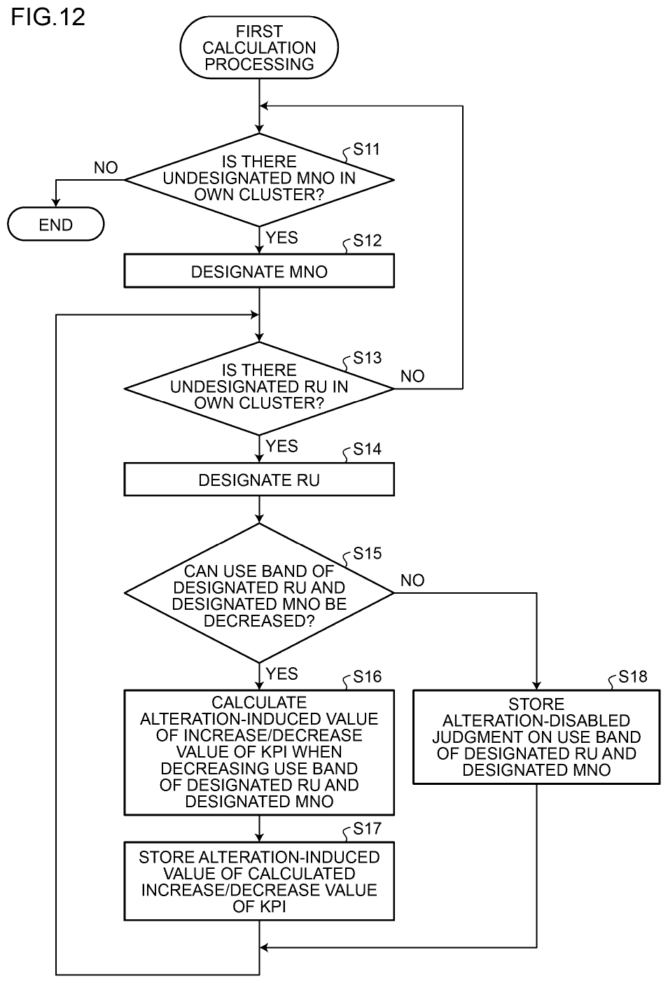

FIG. 12 is a flowchart illustrating an example of a processing operation of the first communication control apparatus 5 related to first calculation processing. The first calculation processing is processing of calculating and storing the alteration-induced value of the increase/decrease value of the KPI when having decreased the allocation quantity of the use bands of the RU 3 for each MNO in the cluster.

The processor 14 in the first communication control apparatus 5 determines whether there is an undesignated MNO in the own cluster (step S11). When there is an undesignated MNO in the own cluster (step S11: Yes), the processor 14 designates the undesignated MNO (step S12). Note that, for example, in a case where the own cluster is a cluster #1, the undesignated MNO will be MNO #1 and #2.

After designating the MNO, the processor 14 determines whether there is an undesignated RU 3 in the own cluster (step S13). Note that, for example, the undesignated RU 3 in the cluster #1 is the RU 3 #1 and #2. When there is an undesignated RU 3 in the own cluster (step S13: Yes), the processor 14 designates the undesignated RU 3 (step S14).

After designating the RU 3, the processor 14 determines whether the allocation quantity of the use bands of the designated MNO and the designated RU 3 can be decreased (step S15). When capable of decreasing the allocation quantity of the use bands of the designated MNO and the designated RU (step S15: Yes), the processor 14 calculates the KPI under an assumption of decreasing the allocation quantity of the use bands of the designated MNO and the designated RU. Furthermore, the processor 14 calculates an alteration-induced value of an increase/decrease value of the KPI, which is a difference between the calculated KPI and the initial KPI (step S16).

The processor 14 stores the calculated alteration-induced value of the increase/decrease value of the KPI of the designated MNO and the designated RU 3 in the intra-cluster evaluation table 23 (step S17). Subsequently, after storing the alteration-induced value in step S17, the processor 14 proceeds to the processing of step S13 to determine whether there is an undesignated RU 3 in the own cluster.

When there is no undesignated RU 3 in the own cluster (step S13: No), the processor 14 proceeds to the processing of step S11 of determining whether there is an undesignated MNO in the own cluster. When there is no undesignated MNO in the own cluster (step S11: No), the processor 14 ends the processing operation illustrated in FIG. 12.

When not capable of decreasing the allocation quantity of the use bands of the designated MNO and the designated RU 3 (step S15: No), the processor 14 judges that the band decrease alteration is disabled and stores the alteration-disabled judgment of the use band of the designated MNO and the designated RU 3 in the intra-cluster evaluation table 23 (step S18). Subsequently, after storing the alteration-disabled judgment of the use band of the designated MNO and the designated RU 3 in the intra-cluster evaluation table 23 in step S18, the processor 14 proceeds to the processing of step S13 of determining whether there is an undesignated RU 3 in the own cluster.

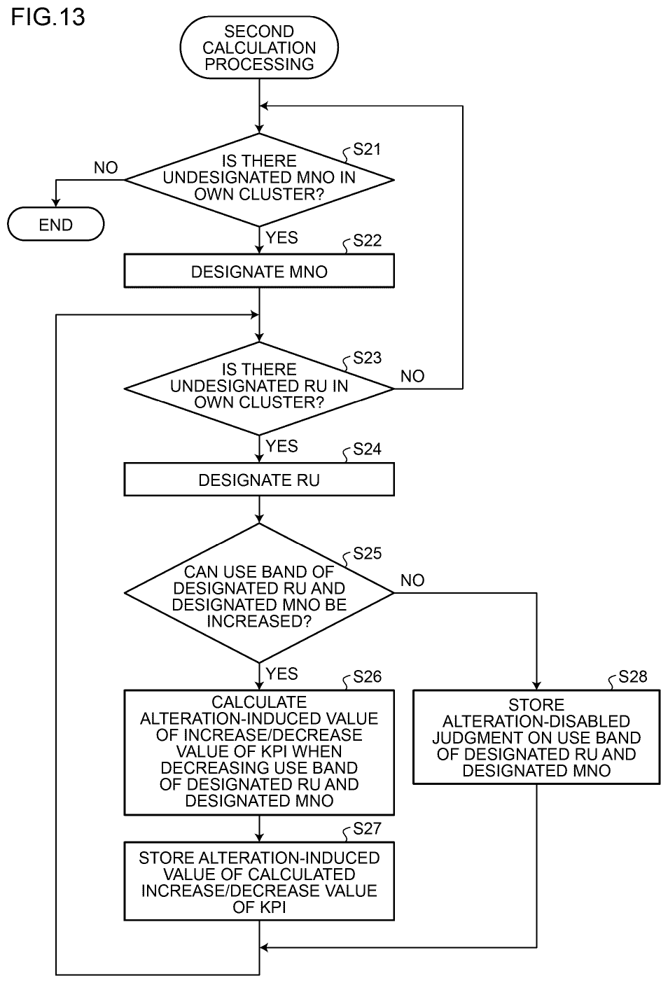

FIG. 13 is a flowchart illustrating an example of a processing operation of the first communication control apparatus 5 related to second calculation processing. The second calculation processing is processing of calculating and storing the alteration-induced value of the increase/decrease value of the KPI when having increased the allocation quantity of the use bands of the RU 3 for each MNO in the cluster.

The processor 14 in the first communication control apparatus 5 determines whether there is an undesignated MNO in the own cluster (step S21). When there is an undesignated MNO in the own cluster (step S21: Yes), the processor 14 designates the undesignated MNO (step S22).

After designating the MNO, the processor 14 determines whether there is an undesignated RU 3 in the own cluster (step S23). When there is an undesignated RU 3 in the own cluster (step S23: Yes), the processor 14 designates the undesignated RU 3 (step S24).

After designating the RU 3, the processor 14 determines whether the allocation quantity of the use bands of the designated MNO and the designated RU 3 can be increased (step S25). When capable of increasing the allocation quantity of the use bands of the designated MNO and the designated RU 3 (step S25: Yes), the processor 14 calculates the KPI under the assumption of increasing the allocation quantity of the use bands of the designated MNO and the designated RU 3.

Furthermore, the processor 14 calculates an alteration-induced value of an increase/decrease value of the KPI, which is a difference between the calculated KPI and the initial KPI (step S26).

The processor 14 stores the calculated alteration-induced value of the increase/decrease value of the KPI of the designated MNO and the designated RU 3 in the intra-cluster evaluation table 23 (step S27). Subsequently, after storing the alteration-induced value in step S27, the processor 14 proceeds to the processing of step S23 to determine whether there is an undesignated RU 3 in the own cluster.

When there is no undesignated RU 3 in the own cluster (step S23: No), the processor 14 proceeds to the processing of step S21 of determining whether there is an undesignated MNO in the own cluster. When there is no undesignated MNO in the own cluster (step S21: No), the processor 14 ends the processing operation illustrated in FIG. 13.

When not capable of increasing the allocation quantity of the use bands of the designated MNO and the designated RU 3 (step S25: No), the processor 14 judges that the band increase alteration is disabled and stores the alteration-disabled state of the use band of the designated MNO and the designated RU 3 in the intra-cluster evaluation table 23 (step S28). Subsequently, after storing the alteration-disabled judgment on the use band of the designated MNO and the designated RU 3 in the intra-cluster evaluation table 23 in step S28, the processor 14 proceeds to the processing of step S23 of determining whether there is an undesignated RU 3 in the own cluster.

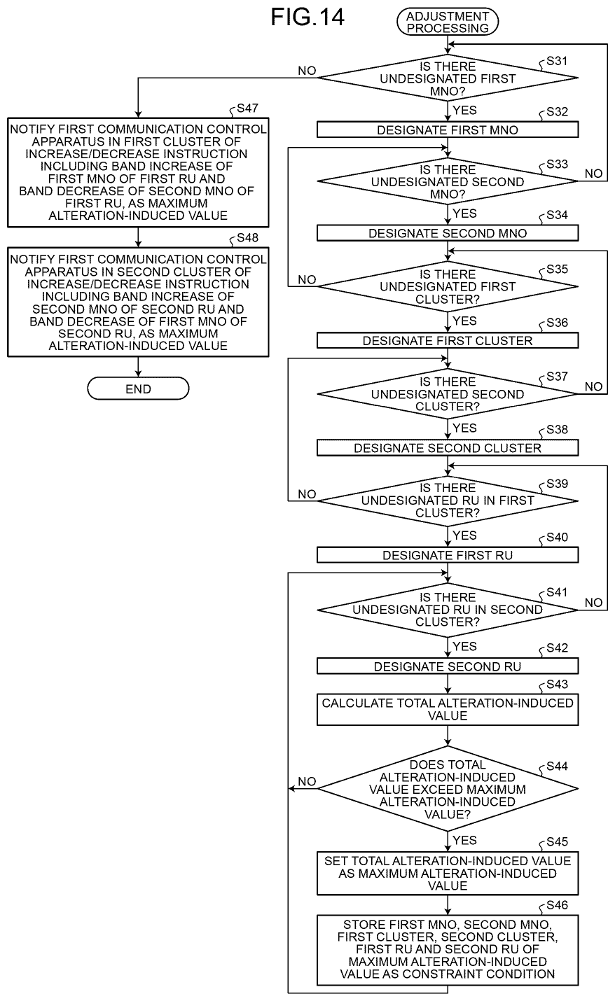

FIG. 14 is a flowchart illustrating an example of a processing operation of the second communication control apparatus 6 related to adjustment processing. The adjustment processing illustrated in FIG. 14 is processing of generating an increase/decrease instruction to alter the use band of each RU 3 in all clusters satisfying the FH capacity constraint condition and the DU calculation resource constraint requirement so as to maximize the alteration-induced value.

The processor 43 in the second communication control apparatus 6 determines whether there is an undesignated first MNO (step S31) When there is an undesignated first MNO (step S31: Yes), the processor 43 designates the undesignated first MNO (step S32).

After designating the first MNO, the processor 43 determines whether there is an undesignated second MNO (step S33). When there is an undesignated second MNO (step S33: Yes), the processor 43 designates the undesignated second MNO (step S34).

After designating the second MNO, the processor 43 determines whether there is an undesignated first cluster (step S35). When there is an undesignated first cluster (step S35: Yes), the processor 43 designates the undesignated first cluster (step S36).

After designating the first cluster, the processor 43 determines whether there is an undesignated second cluster (step S37). When there is an undesignated second cluster (step S37: Yes), the processor 43 designates the undesignated second cluster (step S38).

After designating the second cluster, the processor 43 determines whether there is an undesignated RU 3 in the first cluster (step S39) When there is an undesignated first RU 3 in the first cluster (step S39: Yes), the processor 43 designates the undesignated first RU 3 in the first cluster (step S40).

After designating the first RU 3, the processor 43 determines whether there is an undesignated RU 3 in the second cluster (step S41). When there is an undesignated second RU 3 in the second cluster (step S41: Yes), the processor 43 designates the undesignated second RU 3 in the second cluster (step S42).

After designating the second RU 3, the processor 43 calculates the total alteration-induced value (step S43). Specifically, the processor 43 adds up an alteration-induced value α1, an alteration-induced value α2, an alteration-induced value β1, and an alteration-induced value β2 to calculate a total alteration-induced value. The first alteration-induced value α1 is an alteration-induced value when having increased the allocation quantity of use bands of the first MNO to be allocated to the first RU 3 in the first cluster. The second alteration-induced value α2 is an alteration-induced value when having decreased the allocation quantity of use bands of the second MNO to be allocated to the first RU 3 in the first cluster. The third alteration-induced value β1 is an alteration-induced value when having decreased the allocation quantity of use bands of the first MNO to be allocated to the second RU 3 in the second cluster. The alteration-induced value β2 is an alteration-induced value when having increased the allocation quantity of use bands of the second MNO to be allocated to the second RU 3 in the second cluster.

The processor 43 determines whether the total alteration-induced value exceeds a maximum alteration-induced value (step S44). When the total alteration-induced value exceeds the maximum alteration-induced value (step S44: Yes), the processor 43 sets the total alteration-induced value exceeding the maximum alteration-induced value, as the maximum alteration-induced value (step S45).

After setting the total alteration-induced value as the maximum alteration-induced value, the processor 43 stores the use bands of the first MNO, the second MNO, the first cluster, the second cluster, the first RU 3, and the second RU 3 having the maximum alteration-induced value, in the evaluation result table 52 as constraint conditions (step S46). Note that the evaluation result table 52 stores a constraint condition all corresponding to the alteration-induced value α1, a constraint condition α21 corresponding to the alteration-induced value α2, a constraint condition β11 corresponding to the alteration-induced value β1, and a constraint condition β21 corresponding to the alteration-induced value β2, in the evaluation result table 52. The constraint condition α11 is a constraint condition when having increased the allocation quantity of use bands of the first MNO to be allocated to the first RU 3 in the first cluster. The constraint condition α21 is a constraint condition when having decreased the allocation quantity of use bands of the second MNO to be allocated to the first RU 3 in the first cluster. The constraint condition β11 is a constraint condition when having decreased the allocation quantity of use bands of the first MNO to be allocated to the second RU 3 in the second cluster. The constraint condition β21 is a constraint condition when having increased the allocation quantity of use bands of the second MNO to be allocated to the second RU 3 in the second cluster.

After storing the use band of the maximum alteration-induced value in the evaluation result table 52, the processor 43 returns to the processing of step S41 of determining whether there is an undesignated RU 3 in the second cluster. When there is no undesignated RU 3 in the second cluster (step S41: No), the processor 43 returns to the processing of step S39 of determining whether there is an undesignated RU 3 in the first cluster. When the total alteration-induced value does not exceed the maximum alteration-induced value (step S44: No), the processor 43 returns to the processing of step S41 of determining whether there is an undesignated RU 3 in the second cluster.

When there is no undesignated RU 3 in the first cluster (step S39: No), the processor 43 returns to the processing of step S37 of determining whether there is an undesignated second cluster. When there is no undesignated second cluster (step S37: No), the processor 43 returns to the processing of step S35 for determining whether there is an undesignated first cluster.

When there is no undesignated first cluster (step S35: No), the processor 43 returns to the processing of step S33 of determining whether there is an undesignated second MNO. When there is no undesignated second MNO (step S33: No), the processor 43 returns to the processing of step S31 of determining whether there is an undesignated first MNO.

When there is no undesignated first MNO (step S31: No), the processor 43 notifies the first communication control apparatus 5 #1 in the first cluster of an increase/decrease instruction including the constraint condition all and the constraint condition α21 of the maximum alteration-induced value (step S47). Note that the constraint condition all is a constraint condition in the band increase of the first MNO of the first RU 3. The constraint condition α21 is a constraint condition in the band decrease of the second MNO of the first RU 3. Consequently, the band increase constraint condition all and the band decrease constraint condition α21 of the first RU 3 are used to satisfy the FH capacity constraint condition of the first RU 3.

Furthermore, the processor 43 notifies the first communication control apparatus 5 #2 in the second cluster of an increase/decrease instruction including the constraint condition 011 and the constraint condition 021 of the maximum alteration-induced value (step S48), and ends the processing operation illustrated in FIG. 14. Note that the constraint condition β11 is a constraint condition in the band decrease of the first MNO of the second RU 3. The constraint condition β21 is a constraint condition in the band increase of the second MNO of the second RU 3. Consequently, the band increase constraint condition β21 and the band decrease constraint condition β11 of the second RU 3 are used to satisfy the FH capacity constraint condition of the second RU 3.

Furthermore, the constraint condition α11, the constraint condition β11, the constraint condition α21, and the constraint condition β21 are used to satisfy DU calculation resources for achieving a constant allocation quantity of each MNO in the entire cluster.

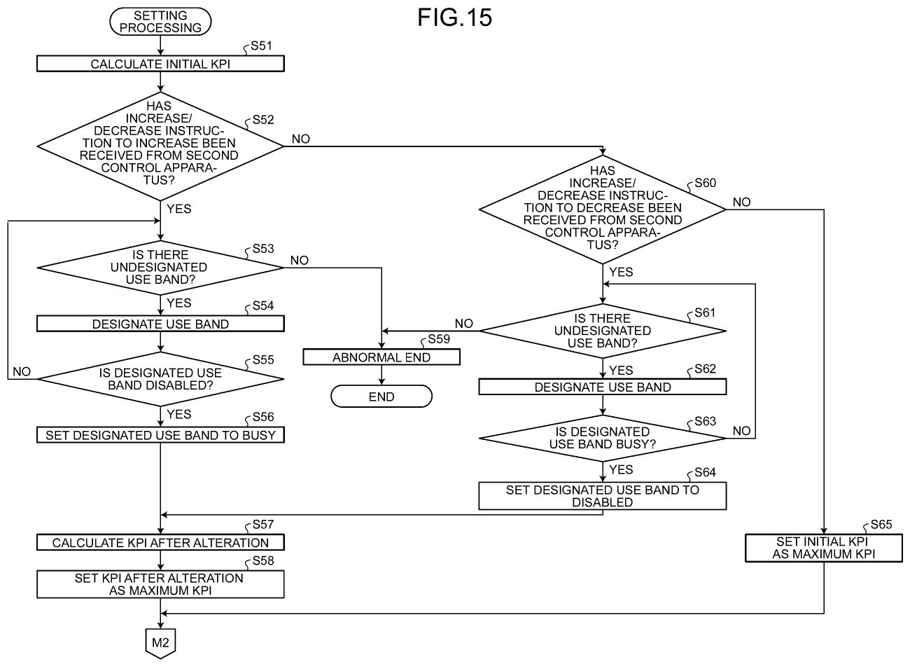

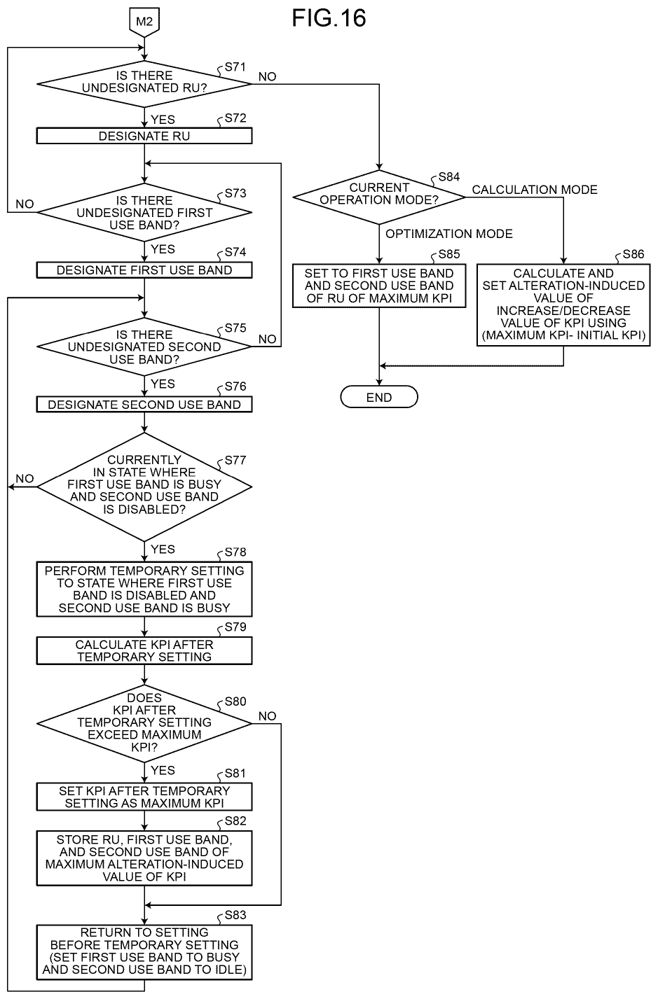

FIGS. 15 and 16 are flowcharts each illustrating an example of a processing operation of the first communication control apparatus 5 related to setting processing. The setting processing is processing of allocating the use bands of the first MNO and the second MNO in the RU 3 in the own cluster in accordance with the increase/decrease instruction from the second communication control apparatus 6.

The processor 14 in the first communication control apparatus 5 calculates an initial KPI (step S51). The processor 14 determines whether an instruction to increase the use band of the RU 3 to be adjusted, which is an increase/decrease instruction in the own cluster, has been received from the second communication control apparatus 6 (step S52). When having received the instruction to increase the use band of the RU 3 to be adjusted (step S52: Yes), the processor 14 determines whether there is an undesignated use band in the RU 3 to be adjusted (step S53).

When there is an undesignated use band in the RU 3 to be adjusted (step S53: Yes), the processor 14 designates the undesignated use band (step S54). After designating the use band in the RU 3 to be adjusted, the processor 14 determines whether the designated use band is disabled (step S55).

When the designated use band is disabled (step S55: Yes), the processor 14 sets the designated use band to busy (step S56) and calculates the KPI after the band alteration (step S57).

The processor 14 sets the calculated KPI after the band alteration as the maximum KPI (step S58), and proceeds to M2 illustrated in FIG. 16.

When there is no undesignated use band in the RU 3 to be adjusted (step S53: No), the processor 14 judges that there is an abnormality (step S59), and ends the processing operation illustrated in FIG. 15. When the designated use band is not disabled (step S55: No), the processor 14 proceeds to the processing of step S53 of determining whether there is an undesignated use band in the RU 3 to be adjusted.

When not having an increase instruction (step S52: No), the processor 14 determines whether an instruction to decrease the use band of the RU 3 to be adjusted, which is an increase/decrease instruction in the own cluster, has been received from the second communication control apparatus 6 (step S60). When having received the instruction to decrease the use band of the RU 3 to be adjusted (step S60: Yes), the processor 14 determines whether there is an undesignated use band in the RU 3 to be adjusted (step S61).

When there is an undesignated use band in the RU 3 to be adjusted (step S61: Yes), the processor 14 designates the undesignated use band (step S62). After designating the use band in the RU 3 to be adjusted, the processor 14 determines whether the designated use band is busy (step S63).

When the designated use band is busy (step S63: Yes), the processor 14 sets the designated use band to disabled (step S64), and proceeds to the processing of step S57 of calculating the KPI after the band alteration.

When there is no undesignated use band in the RU 3 to be adjusted (step S61: No), the processor 14 proceeds to the processing of step S59 of judging abnormality. In addition, in a case where the designated use band is not disabled (step S63: No), the processor 14 proceeds to the processing of step S61 of determining whether there is an undesignated use band in the RU 3 to be adjusted.

When not having received the instruction to decrease the use band of the RU 3 to be adjusted (step S60: No), the processor 14 sets the initial KPI as the maximum KPI (step S65), and proceeds to M2 illustrated in FIG. 16.

In M2 illustrated in FIG. 16, the processor 14 determines whether there is an undesignated RU 3 in the own cluster (step S71). When there is an undesignated RU 3 (step S71: Yes), the processor 14 designates the undesignated RU 3 (step S72).

After designating an undesignated RU 3, the processor 14 determines whether there is an undesignated first use band in the designated RU 3 (step S73). When there is an undesignated first use band (step S73: Yes), the processor 14 designates the first use band (step S74).

After designating the first use band, the processor 14 determines whether there is an undesignated second use band in the designated RU 3 (step S75) When there is an undesignated second use band (step S75: Yes), the processor 14 designates the second use band (step S76).

After designating the second use band, the processor 14 determines whether the first use band in the designated RU 3 is busy and the second use band is disabled (step S77). When the first use band in the designated RU 3 is busy and the second use band is disabled (step S77: Yes), the processor 14 performs temporary setting to a state where the first use band in the designated RU 3 is disabled and the second use band is busy (step S78).

Subsequently, after the temporary setting, the processor 14 calculates the KPI of the RU 3 after the temporary setting (step S79). After calculating the KPI of the RU 3 after the temporary setting, the processor 14 determines whether the calculated KPI exceeds the maximum KPI (step S80).

When the calculated KPI exceeds the maximum KPI (step S80: Yes), the processor 14 sets the calculated KPI as the maximum KPI (step S81). Furthermore, the processor 14 stores the designated RU 3, the first use band, and the second use band having the alteration-induced value as the maximum KPI (step S82). Furthermore, the processor 14 returns to the allocation list of the first use band and the second use band of the designated RU 3 before the temporary setting in step S78 (step S83), and proceeds to the processing of step S75 of determining whether there is an undesignated second use band in the designated RU 3.

In addition, in a case where the calculated KPI does not exceed the maximum KPI (step S80: No), the processor 14 proceeds to the processing of step S83 of returning to the allocation list of the first use band and the second use band of the designated RU 3 before the temporary setting.

When the state is other than the state where the first use band in the designated RU 3 is busy and the second use band is disabled (step S77: No), the processor 14 proceeds to the processing of step S75 of determining whether there is an undesignated second use band in the designated RU 3.

When there is no undesignated second use band (step S75: No), the processor 14 proceeds to the processing of step S73 of determining whether there is an undesignated first use band in the designated RU 3. When there is no undesignated first use band (step S73: No), the processor 14 proceeds to the processing of step S71 of determining whether there is an undesignated RU 3.

When there is no undesignated RU 3 (step S71: No), and when the current operation mode is an optimization mode (step S84), the processor 14 sets the first use band and the second use band of the maximum KPI (step S85), and ends the processing operation illustrated in FIG. 16.

When the current operation mode is the calculation mode (step S84), the processor 14 calculates and sets the alteration-induced value of the increase/decrease value of the KPI using (maximum KPI-initial KPI) (step S86), and ends the processing operation illustrated in FIG. 16.

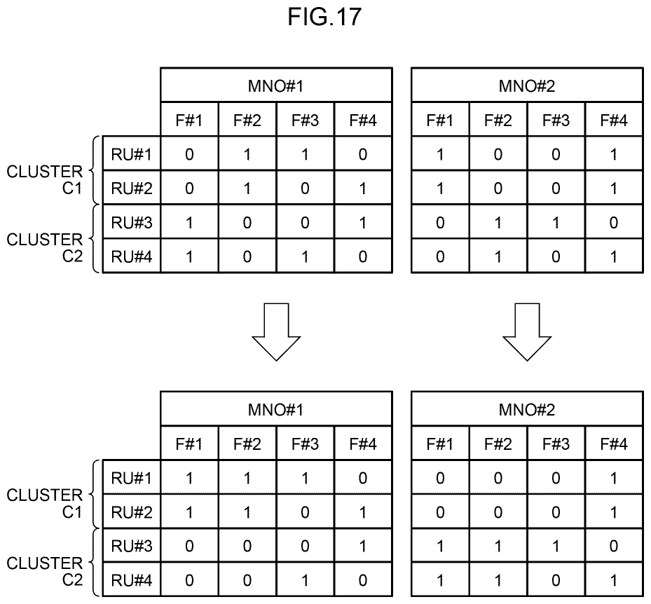

FIG. 17 is an explanatory diagram illustrating an example of the evaluation table 51 before and after execution of the setting processing. The allocation quantity of the use band of RU 3 #1 of the MNO #1 in the cluster #1 before execution of the setting processing is set to two bands, and the allocation quantity of the use band of RU 3 #1 of the MNO #2 in the cluster #1 is set to two bands. The allocation quantity of the use band of RU 3 #2 of the MNO #1 in the cluster #1 before execution of the setting processing is set to two bands, and the allocation quantity of the use band of RU 3 #2 of the MNO #2 in the cluster #1 is set to two bands. Furthermore, the allocation quantity of the use band of RU 3 #3 of the MNO #1 in the cluster #2 before execution of the setting processing is set to two bands, and the allocation quantity of the use band of RU 3 #3 of the MNO #2 in the cluster #2 is set to two bands. The allocation quantity of the use band of RU 3 #4 of the MNO #1 in the cluster #2 before execution of the setting processing is set to two bands, and the allocation quantity of the use band of RU 3 #4 of the MNO #2 in the cluster #2 is set to two bands.

The second communication control apparatus 6 executes the setting processing in a case where the allocation quantity of the use bands of the MNO #1 in the cluster #1 is increased, for example. The allocation quantity of the use band of RU 3 #1 of the MNO #1 in the cluster #1 after execution of the setting processing is set to three bands, and the allocation quantity of the use band of RU 3 #1 of the MNO #2 in the cluster #1 is set to one band. The allocation quantity of the use band of RU 3 #2 of the MNO #1 in the cluster #1 after execution of the setting processing is set to three bands, and the allocation quantity of the use band of RU 3 #2 of the MNO #2 in the cluster #1 is set to one band.

The allocation quantity of the use band of RU 3 #3 of the MNO #1 in the cluster #2 after execution of the setting processing is set to one band, and the allocation quantity of the use band of RU 3 #3 of the MNO #2 in the cluster #2 is set to three bands. The allocation quantity of the use band of RU 3 #4 of the MNO #1 in the cluster #2 after execution of the setting processing is set to one band, and the allocation quantity of the use band of RU 3 #4 of the MNO #2 in the cluster #2 is set to three bands.

That is, the allocation quantity of the use bands of the MNO #1 is set to six bands in the cluster #1, and the allocation quantity of the use bands of the MNO #1 is set to two bands in the cluster #2. Furthermore, the allocation quantity of the use bands of the MNO #2 is set to six bands in the cluster #2, and the allocation quantity of the use bands of the MNO #2 is set to two bands in the cluster #1. That is, even when the allocation quantity of the use band to be allocated to the MNO #1 in the cluster #1 has been increased, the allocation quantity of the use band to be allocated to the MNO #1 in the cluster #2 is decreased. Even when the allocation quantity of the use band for each MNO in the cluster has been altered, the system capacity can be expanded by satisfying the FH capacity constraint condition and the DU calculation resource constraint requirement.

The second communication control apparatus 6 of the first exemplary embodiment receives the alteration-induced value from each first communication control apparatus 5. The second communication control apparatus 6 decides, for each cluster, a constraint condition that maximizes the alteration-induced value of each RU 3 in all the clusters and under which the capacity of the use band allocated to each RU 3 satisfies a first prescribed quantity and the allocation quantity of the use band to be allocated to each MNO in the entire cluster satisfies a second prescribed quantity. The second communication control apparatus 6 notifies the first communication control apparatus 5 that manages each cluster of the constraint condition decided for each cluster. As a result, even when unevenness of the number of UE 2 of a specific MNO occurs in the cluster, the FH capacity constraint condition of the RU 3 in the cluster is satisfied, and the DU calculation resource constraint requirement, being the allocation quantity of the use bands of each MNO in the entire cluster, is satisfied. In addition, the system capacity can be expanded.

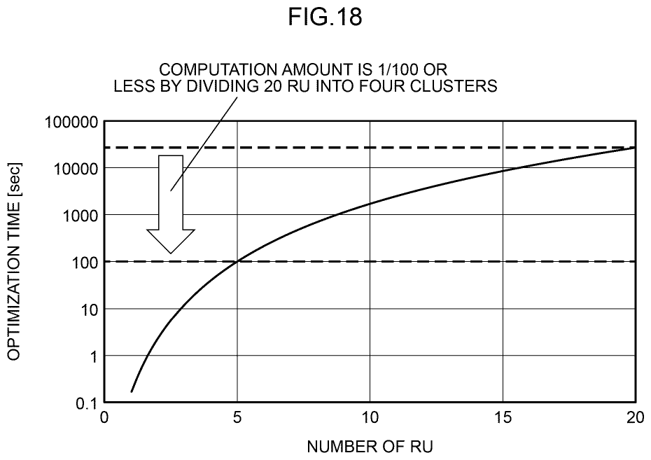

FIG. 18 is an explanatory diagram illustrating time to be used for optimization according to the number of RUs in a cluster. For example, FIG. 18 illustrates a case where the total number of RU 3 in the radio system 1 is twenty and all the RU 3 are divided into four clusters, and illustrates a relationship between a time length corresponding to the computation amount to be used for the optimization using the second communication control apparatus 6 by clustering and the number of RUs. The curve is the amount of time according to the number of RUs. The computation amount with clustering is only 1/100 of the operation amount without clustering.

The radio system according to the first exemplary embodiment has been described as an exemplary case of including the first communication control apparatus 5 #1 that manages the cluster #1, the first communication control apparatus 5 #2 that manages the cluster #2, and the second communication control apparatus 6 that adjusts the use band of the MNO between the clusters. However, the radio system is not limited thereto, and an embodiment thereof will be described below as a second exemplary embodiment.

### Second Exemplary Embodiment

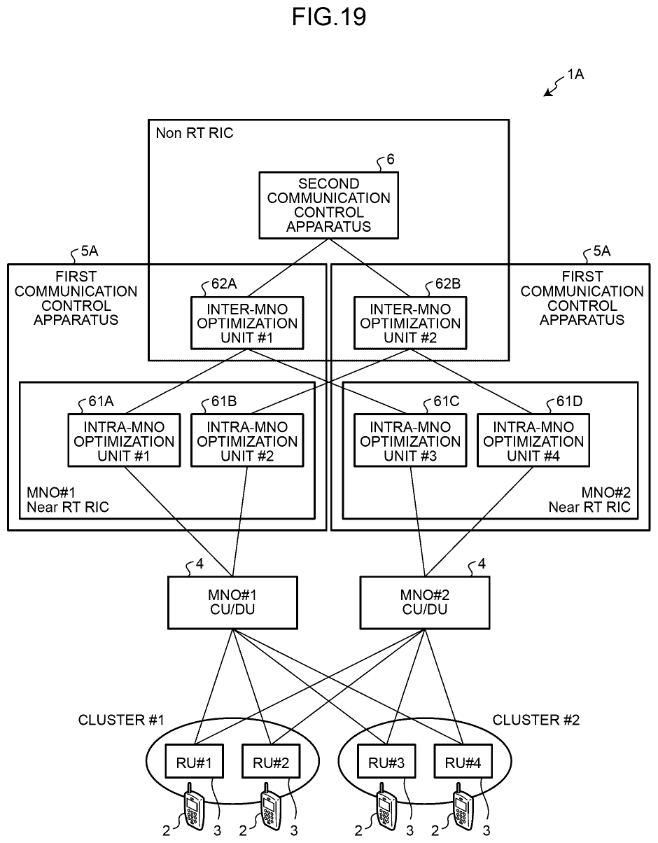

FIG. 19 is an explanatory diagram illustrating an example of a configuration of a radio system 1A according to the second exemplary embodiment. A same reference sign will be given to a configuration that is same as the configuration of the radio system 1 in the first exemplary embodiment, and description of the duplicate configuration and operation will be omitted. The radio system 1A illustrated in FIG. 19 is different from the radio system 1 illustrated in FIG. 1 in including a first communication control apparatus 5A instead of the first communication control apparatus 5.

The first communication control apparatus 5A of the cluster #1 illustrated in FIG. 19 includes an intra-MNO optimization unit 61A #1, an intra-MNO optimization unit 61B #2, and an inter-MNO optimization unit 62A #1. The intra-MNO optimization unit 61A #1 is connected to the CU/DU 4 of the MNO #1, and adjusts the allocation quantity of the use bands of the RU 3 #1 and #2 in the MNO #1 in the cluster #1. The intra-MNO optimization unit 61B #2 is connected to the CU/DU 4 of the MNO #1, and adjusts the allocation quantity of the use band of the RU 3 #3 and #4 in the MNO #1 in the cluster #2. The inter-MNO optimization unit 62A #1 adjusts the allocation quantity of the use band of the RU 3 #1 and #2 between the MNO #1 in the cluster #1.

The first communication control apparatus 5A #2 in the cluster #2 includes an intra-MNO optimization unit 61C #3, an intra-MNO optimization unit 61D #4, and an inter-MNO optimization unit 62B #2. The intra-MNO optimization unit 61C #3 is connected to the CU/DU 4 of the MNO #2, and adjusts the allocation quantity of the use band of the RU 3 #1 and #2 in the MNO #2 in the cluster #1. The intra-MNO optimization unit 61D #4 is connected to the CU/DU 4 of the MNO #2, and adjusts the allocation quantity of the use band of the RU 3 #3 and #4 in the MNO #2 in the cluster #2. The inter-MNO optimization unit 62B #2 adjusts the allocation quantity of the use band of the RU 3 #3 and #4 between the MNO #2 in the cluster #2.

The second communication control apparatus 6 adjusts the allocation quantity of the use band of the RU 3 of the MNO #1 and the MNO #2 between the clusters, namely, between the cluster #1 and cluster #2.

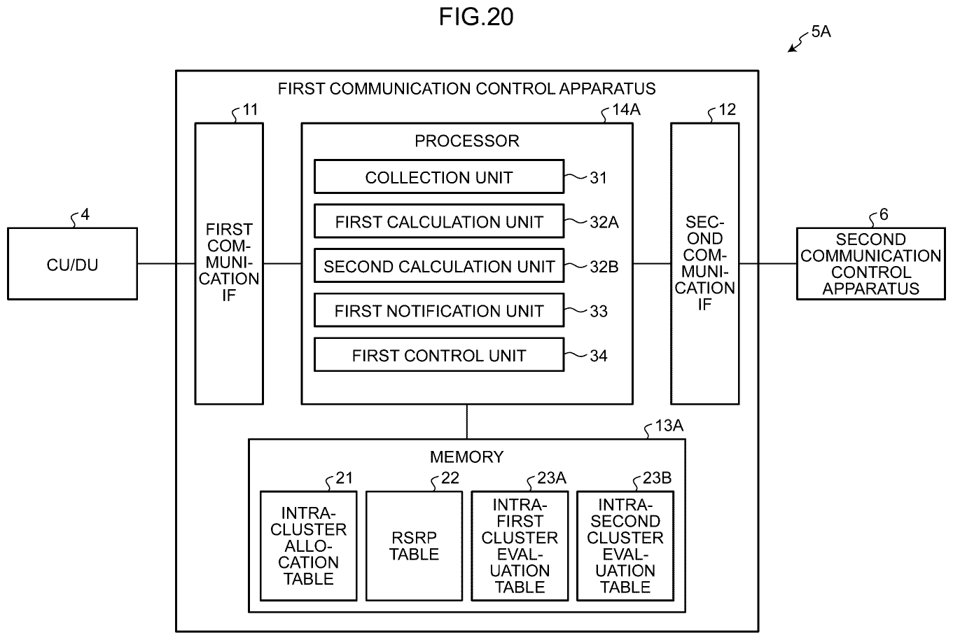

FIG. 20 is a block diagram illustrating an example of the first communication control apparatus 5A. The first communication control apparatus 5A includes a first communication IF 11, a second communication IF 12, memory 13A, and a processor 14A. The first communication IF 11 is a communication IF connected to the CU/DU 4. The second communication IF 12 is a communication IF connected to the second communication control apparatus 6. The memory 13A includes an intra-cluster allocation table 21, an RSRP table 22, an intra-first cluster evaluation table 23A, and an intra-second cluster evaluation table 23B.

The processor 14A includes, as functions, a collection unit 31, a first calculation unit 32A, a second calculation unit 32B, a first notification unit 33, and a first control unit 34. The first calculation unit 32A calculates the alteration-induced value according to the increase/decrease value of the first KPI. The second calculation unit 32B calculates an alteration-induced value according to the second KPI.

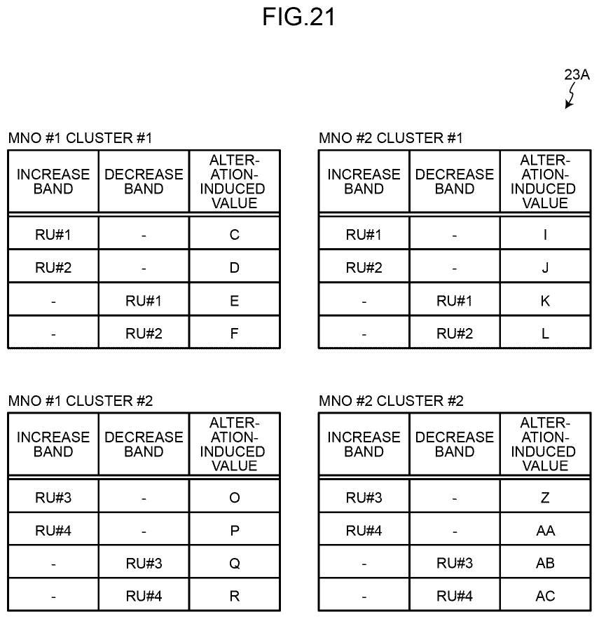

FIG. 21 is an explanatory diagram illustrating an example of the intra-first cluster evaluation table 23A. The inter-MNO optimization unit 62A #1 calculates an alteration-induced value C according to the increase/decrease value of the first KPI at a single increase of the allocation quantity of the use band of the RU 3 #1 in the MNO #1 in the cluster #1. The inter-MNO optimization unit 62A #1 calculates an alteration-induced value D according to the increase/decrease value of the first KPI at a single increase of the allocation quantity of the use band of the RU 3 #2 in the MNO #1 in the cluster #1. The inter-MNO optimization unit 62A #1 calculates an alteration-induced value E according to the increase/decrease value of the first KPI at a single decrease of the allocation quantity of the use band of the RU 3 #1 in the MNO #1 in the cluster #1. The inter-MNO optimization unit 62A #1 calculates an alteration-induced value F according to the increase/decrease value of the first KPI at a single decrease of the allocation quantity of the use band of the RU 3 #2 in the MNO #1 in the cluster #1.

The inter-MNO optimization unit 62A #1 calculates an alteration-induced value I according to the increase/decrease value of the first KPI at a single increase of the allocation quantity of the use band of the RU 3 #1 in the MNO #2 in the cluster #1. The inter-MNO optimization unit 62A #1 calculates an alteration-induced value J according to the increase/decrease value of the first KPI at a single increase of the allocation quantity of the use band of the RU 3 #2 in the MNO #2 in the cluster #1. The inter-MNO optimization unit 62A #1 calculates an alteration-induced value K according to the increase/decrease value of the first KPI at a single decrease of the allocation quantity of the use band of the RU 3 #1 in the MNO #2 in the cluster #1. The inter-MNO optimization unit 62A #1 calculates an alteration-induced value L according to the increase/decrease value of the first KPI at a single decrease of the allocation quantity of the use band of the RU 3 #2 in the MNO #2 in the cluster #1. Subsequently, the inter-MNO optimization unit 62A #1 stores the alteration-induced values C, D, E, F, I, J, K, and L of the first KPI in the intra-first cluster evaluation table 23A.

The inter-MNO optimization unit 62B #2 calculates an alteration-induced value O according to the increase/decrease value of the first KPI at a single increase of the allocation quantity of the use band of the RU 3 #3 in the MNO #1 in the cluster #2. The inter-MNO optimization unit 62B #2 calculates an alteration-induced value P according to the increase/decrease value of the first KPI at a single increase of the allocation quantity of the use band of the RU 3 #4 in the MNO #1 in the cluster #2. The inter-MNO optimization unit 62B #2 calculates an alteration-induced value Q according to the increase/decrease value of the first KPI at a single decrease of the allocation quantity of the use band of the RU 3 #3 in the MNO #1 in the cluster #2. The inter-MNO optimization unit 62B #2 calculates an alteration-induced value R according to the increase/decrease value of the first KPI at a single decrease of the allocation quantity of the use band of the RU 3 #4 in the MNO #1 in the cluster #2.

The inter-MNO optimization unit 62B #2 calculates an alteration-induced value Z according to the increase/decrease value of the first KPI at a single increase of the allocation quantity of the use band of the RU 3 #3 in the MNO #2 in the cluster #2. The inter-MNO optimization unit 62B #2 calculates an alteration-induced value AA according to the increase/decrease value of the first KPI at a single increase of the allocation quantity of the use band of the RU 3 #4 in the MNO #2 in the cluster #2. The inter-MNO optimization unit 62B #2 calculates an alteration-induced value AB according to the increase/decrease value of the first KPI at a single decrease of the allocation quantity of the use band of the RU 3 #3 in the MNO #2 in the cluster #2. The inter-MNO optimization unit 62B #2 calculates an alteration-induced value AC according to the increase/decrease value of the first KPI at a single decrease of the allocation quantity of the use band of the RU 3 #4 in the MNO #2 in the cluster #2. Subsequently, the inter-MNO optimization unit 62B #2 stores the alteration-induced values O, P, Q, R, Z, AA, AB, and AC of the first KPI in the intra-first cluster evaluation table 23A.

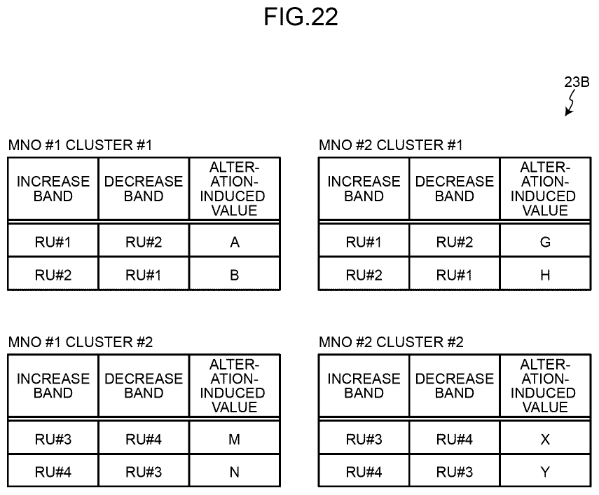

FIG. 22 is an explanatory diagram illustrating an example of the intra-second cluster evaluation table 23B. The intra-MNO optimization unit 61A #1 calculates an alteration-induced value A of the second KPI to be obtained by increasing the allocation quantity of the use band of the RU 3 #1 in the cluster #1 by a predetermined number and decreasing the allocation quantity of the use band of the RU 3 #2 in the cluster #1 by a predetermined number in the MNO #1 in the cluster #1. The intra-MNO optimization unit 61A #1 calculates an alteration-induced value B of the second KPI to be obtained by increasing the allocation quantity of the use band of the RU 3 #2 in the cluster #1 by a predetermined number and decreasing the allocation quantity of the use band of the RU 3 #1 in the cluster #1 by a predetermined number in the MNO #1 in the cluster #1. The intra-MNO optimization unit 61A #1 stores the alteration-induced value A and the alteration-induced value B of the second KPI in the intra-second cluster evaluation table 23B.

The intra-MNO optimization unit 61B #2 calculates an alteration-induced value M of the second KPI to be obtained by increasing the allocation quantity of the use band of the RU 3 #3 in the cluster #2 by a predetermined number and decreasing the allocation quantity of the use band of the RU 3 #4 in the cluster #2 by a predetermined number in the MNO #1 in the cluster #2. The intra-MNO optimization unit 61B #2 calculates an alteration-induced value N of the second KPI to be obtained by increasing the allocation quantity of the use band of the RU 3 #4 in the cluster #2 by a predetermined number and decreasing the allocation quantity of the use band of the RU 3 #3 in the cluster #2 by a predetermined number in the MNO #1 in the cluster #2. The intra-MNO optimization unit 61B #2 stores the alteration-induced value M and the alteration-induced value N of the second KPI in the intra-second cluster evaluation table 23B.

The intra-MNO optimization unit 61C #3 calculates an alteration-induced value G of the second KPI to be obtained by increasing the allocation quantity of the use band of the RU 3 #1 in the cluster #1 by a predetermined number and decreasing the allocation quantity of the use band of the RU 3 #2 in the cluster #1 by a predetermined number in the MNO #2 in the cluster #1. The intra-MNO optimization unit 61C #3 calculates an alteration-induced value H of the second KPI to be obtained by increasing the allocation quantity of the use band of the RU 3 #2 in the cluster #1 by a predetermined number and decreasing the allocation quantity of the use band of the RU 3 #1 in the cluster #1 by a predetermined number in the MNO #2 in the cluster #1. The intra-MNO optimization unit 61C #3 stores the alteration-induced value H and the alteration-induced value G of the second KPI in the intra-second cluster evaluation table 23B.

The intra-MNO optimization unit 61D #4 calculates an alteration-induced value X of the second KPI to be obtained by increasing the allocation quantity of the use band of the RU 3 #3 in the cluster #2 by a predetermined number and decreasing the allocation quantity of the use band of the RU 3 #4 in the cluster #2 by a predetermined number in the MNO #2 in the cluster #2. The intra-MNO optimization unit 61D #4 calculates an alteration-induced value Y of the second KPI to be obtained by increasing the allocation quantity of the use band of the RU 3 #4 in the cluster #2 by a predetermined number and decreasing the allocation quantity of the use band of the RU 3 #3 in the cluster #2 by a predetermined number in the MNO #2 in the cluster #2. The intra-MNO optimization unit 61D #4 stores the alteration-induced value X and the alteration-induced value Y of the second KPI in the intra-second cluster evaluation table 23B.

The first notification unit 33 in the first communication control apparatus 5A #1 notifies the second communication control apparatus 6 of information including the alteration-induced values A, B, G, and H of the second KPI of the cluster #1 and the alteration-induced values C, D, E, F, I, J, K, and L of the first KPI.

The first notification unit 33 in the first communication control apparatus 5A #2 notifies the second communication control apparatus 6 of information including the alteration-induced values M, N, X, and Y of the second KPI and the alteration-induced values O, P, Q, R, Z, AA, AB, and AC of the first KPI in the cluster #2.

The second communication control apparatus 6 receives the alteration-induced value of the first KPI of the cluster #1, the alteration-induced value of the second KPI of the cluster #1, the alteration-induced value of the first KPI of the cluster #2, and the alteration-induced value of the second KPI of the cluster #2, and stores each alteration-induced value in the evaluation result table 52.

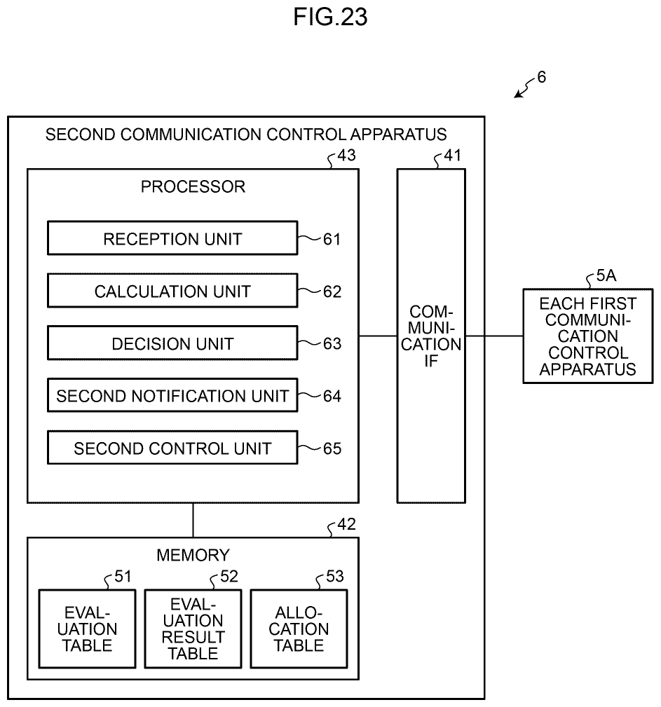

FIG. 23 is a block diagram illustrating an example of the second communication control apparatus 6. The second communication control apparatus 6 illustrated in FIG. 23 includes a communication IF 41, memory 42, and a processor 43. The communication IF 41 is an IF that communicates with each first communication control apparatus 5A.

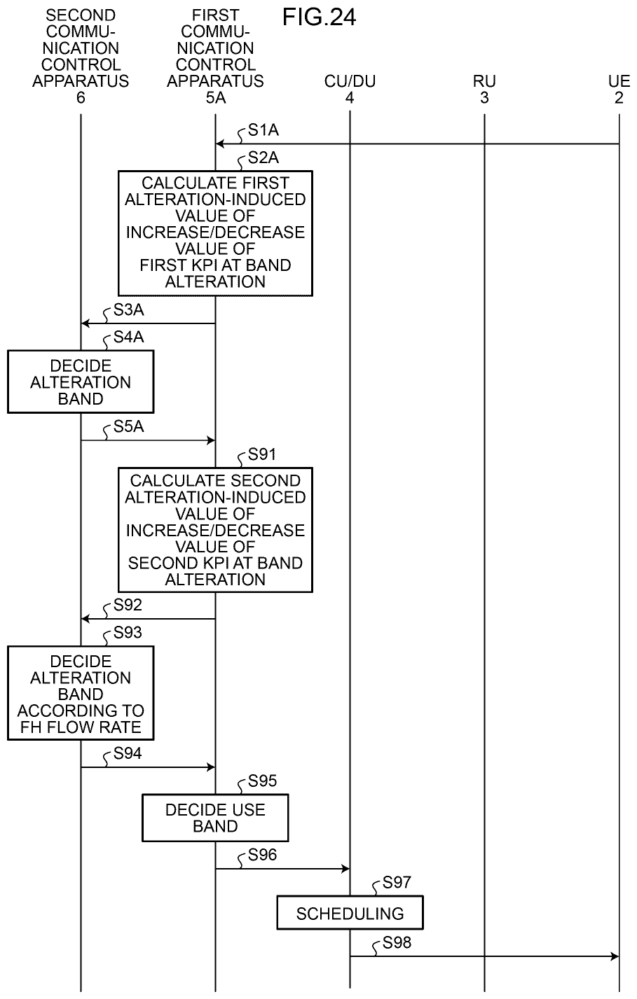

FIG. 24 is a sequence diagram illustrating an example of a band allocation method according to the second exemplary embodiment. The collection unit 31 in the first communication control apparatus 5A collects, through each RU 3 in the own cluster, RSRP information between the RU 3 and the UE 2 connected to each other via radio connection (step S1A).

Based on the RSRP information collected from all the UE 2 in the own cluster, the first calculation unit 32A in the first communication control apparatus 5A calculates the first alteration-induced value according to the increase/decrease value of the first KPI when increasing/decreasing the allocation quantity of use bands of each RU 3 for each MNO (step S2A). Specifically, based on the RSRP information, the calculation unit 32 calculates the first KPI when having increased the allocation quantity of use bands of each RU 3 for each MNO, and calculates a first alteration-induced value according to an increase/decrease value which is a difference between the calculated first KPI and the initial first KPI. In addition, based on the RSRP information, the calculation unit 32 calculates the first KPI when having decreased the allocation quantity of use bands of each RU 3 for each MNO, and calculates the first alteration-induced value according to an increase/decrease value which is a difference between the calculated first KPI and the initial first KPI. Subsequently, the first notification unit 33 notifies the second communication control apparatus 6 of information including the first alteration-induced value at the time of band alteration for each RU 3 in the own cluster for each MNO (step S3A).

The second communication control apparatus 6 receives information including the first alteration-induced value at the time of band alteration of each RU 3 for each MNO in the cluster from each first communication control apparatus 5A. The decision unit 63 in the second communication control apparatus 6 decides the alteration band maximizing the first alteration-induced value based on the first alteration-induced value at the time of band alteration of each RU 3 for each MNO in all clusters (step S4A). That is, the decision unit 63 decides the presence or absence of the use band of each RU 3 for each MNO in all clusters that satisfies the DU calculation resource constraint requirement, as the alteration band that is the evaluation result. The second communication control apparatus 6 notifies each first communication control apparatus 5A of the alteration band that is the evaluation result decided (step S5A).

Based on the RSRP information collected from all the UE 2 in the own cluster, the second calculation unit 32B in the first communication control apparatus 5A calculates a second alteration-induced value according to the second KPI when increasing/decreasing the use band for each combination of the RU 3 for each MNO (step S91). Subsequently, the first notification unit 33 notifies the second communication control apparatus 6 of information including the second alteration-induced value at the time of band alteration for each combination of the RU 3 in the own cluster for each MNO (step S92).

The second communication control apparatus 6 receives information including the second alteration-induced value for each combination of the RU 3 for each MNO in the cluster from each first communication control apparatus 5A. Based on the second alteration-induced value for each combination of the RU 3 for each MNO in all clusters, the decision unit 63 decides the presence or absence of the use band of each RU 3 for each MNO in all clusters that satisfies the FH capacity constraint requirement that maximizes the second alteration-induced value as the alteration band that is the evaluation result (step S93). The second communication control apparatus 6 notifies each first communication control apparatus 5A of the alteration band that is the evaluation result decided (step S94).

When having received the alteration band from the second communication control apparatus 6, each first communication control apparatus 5A decides the use band corresponding to each MNO for each RU 3 in the own cluster, as a piece of the allocation list in accordance with the alteration band (step S95). After deciding the use band, each first communication control apparatus 5A notifies the CU/DU 4 of the MNO of the use band (step S96).

Each CU/DU 4 performs scheduling of a use band notified from each first communication control apparatus 5A (step S97). Furthermore, the CU/DU 4 transmits the scheduling result of the use band to each UE 2 in the own cell (step S98). As a result, the UE2 transmits and receives data to and from the CU/DU 4 based on the scheduling result of the use band.

The second communication control apparatus 6 according to the second exemplary embodiment receives the first alteration-induced value and the second alteration-induced value from each first communication control apparatus 5A. The second communication control apparatus 6 decides, for each cluster, a constraint information that maximizes the first alteration-induced value and the second alteration-induced value of each RU 3 in all the clusters and under which the capacity of the use band allocated to each RU 3 satisfies a first prescribed quantity and the allocation quantity of the use band to be allocated to each MNO in the entire cluster satisfies a second prescribed quantity. The second communication control apparatus 6 notifies the first communication control apparatus 5 that manages each cluster of the constraint condition decided for each cluster. As a result, even when unevenness of the number of UE 2 of a specific MNO occurs in the cluster, the FH capacity constraint condition of the RU 3 in the cluster is satisfied, and the DU calculation resource constraint requirement, being the allocation quantity of the use bands of each MNO in the entire cluster, is satisfied. In addition, the system capacity can be expanded.

Although the radio system 1 (1A) of the exemplary embodiment has a configuration in which the first communication control apparatus 5 (5A) and the second communication control apparatus 6 are individually provided, the second communication control apparatus 6 may execute processing of the first communication control apparatus 5 (5A) and can be appropriately altered.

Although the frequency band is exemplified as the radio resource allocated to the MNO by the RU 3, the radio resource is not limited to the frequency band, and may be a time, a code, or the like, and can be appropriately altered.

Although the KPI is exemplified as the influence evaluation value, for example, it is also allowable to use other values such as a change amount of proportional fairness (PF) utility which is an index value of fairness of allocation of a use band and a system throughput, and the value can be appropriately altered.

According to one aspect of the communication control apparatus disclosed in the present application, it is possible to expand the system capacity.

All examples and conditional language provided herein are intended for pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A communication control apparatus that manages a plurality of radio apparatuses allocated for each cluster and shared by a plurality of operators, the communication control apparatus comprising:
a controller that allocates a radio resource of each operator for each radio apparatus in each cluster in accordance with a constraint condition decided;
a calculator that calculates an alteration-induced value related to an evaluation value for each operator of each radio apparatus in each cluster under an assumption of increasing/decreasing a radio resource allocated to each operator of each radio apparatus in the cluster; and
decision processor circuitry that decides, for each cluster, a constraint condition that maximizes the alteration-induced value of each radio apparatus in all the clusters and under which a capacity of a radio resource allocated to each radio apparatus satisfies a first prescribed quantity and a calculation capacity of a radio resource allocated to each operator in an entire cluster satisfies a second prescribed quantity.

2. A radio system comprising:
a plurality of radio apparatuses allocated for each cluster and shared by a plurality of operators;
a first communication control apparatus that is provided for each cluster and manages the plurality of radio apparatuses in an own cluster; and
a second communication control apparatus connected to the first communication control apparatus, wherein
the first communication control apparatus includes:
a controller that allocates a radio resource of each operator for each radio apparatus in the own cluster in accordance with a constraint condition decided by the second communication control apparatus;
a calculator that calculates an alteration-induced value related to an evaluation value for each operator of each radio apparatus in the own cluster under an assumption of increasing/decreasing the radio resource allocated to each operator of each radio apparatus in the own cluster; and
first notification processor circuitry that notifies the second communication control apparatus of the calculated alteration-induced value for each operator of each radio apparatus in the own cluster, and
the second communication control apparatus includes:
a receiver that receives the alteration-induced value individually from each first communication control apparatus;
decision processor circuitry that decides, for each cluster, a constraint condition that maximizes the alteration-induced value of each radio apparatus in all the clusters and under which a capacity of the radio resource allocated to each radio apparatus satisfies a first prescribed quantity and a calculation capacity of a radio resource allocated to each operator in an entire cluster satisfies a second prescribed quantity; and
second notification processor circuitry that notifies the first communication control apparatus that manages each cluster of the decided constraint condition for each cluster.

3. The radio system according to claim 2, wherein
the calculator
includes collection processor circuitry that collects reception quality information from a terminal apparatus that performs radio communication with the radio apparatus to the radio apparatus in the own cluster, and
calculates the alteration-induced value related to the evaluation value for each operator of each radio apparatus in the own cluster under an assumption of increasing/decreasing the radio resource of each operator of each radio apparatus in the own cluster using each piece of the collected reception quality information.

4. The radio system according to claim 2, wherein
the first communication control apparatus includes:
a first calculator that calculates a first alteration-induced value related to a first evaluation value for each operator of each radio apparatus in the own cluster under an assumption of increasing/decreasing the radio resource of each operator of each radio apparatus in the own cluster;
a second calculator that calculates a second alteration-induced value related to a second evaluation value for each combination of radio apparatuses of each operator, enabling the capacity of the radio resource of each radio apparatus in the own cluster to satisfy a first prescribed quantity under an assumption of increasing/decreasing the radio resource of each operator for each combination of a plurality of radio apparatuses in the own cluster; and
the first notification processor circuitry that notifies the second communication control apparatus of the calculated first alteration-induced value and the second alteration-induced value, and
the second communication control apparatus includes:
the receiver that receives the first alteration-induced value and the second alteration-induced value individually from each first communication control apparatus; and
the decision processor circuitry that decides, for each cluster, a constraint information that maximizes the first alteration-induced value and the second alteration-induced value of each radio apparatus in all the clusters and under which a capacity of a radio resource allocated to each radio apparatus satisfies the first prescribed quantity and a calculation capacity of a radio resource allocated to each operator in an entire cluster satisfies the second prescribed quantity.

5. The radio system according to claim 4, wherein the second calculator calculates the second alteration-induced value related to the second evaluation value under an assumption of increasing/decreasing radio resources of one or other radio apparatuses constituting a combination of the radio apparatuses in the own cluster, specifically, under an assumption of increasing the radio resource of the one radio apparatus and decreasing the radio resource of another radio apparatus.

6. The radio system according to claim 3, wherein the reception quality information is Reference Signal Received Power (RSRP) between the terminal apparatus and the radio apparatus.

7. The radio system according to claim 2, wherein the radio resource is an allocation quantity of use bands.

8. A communication control apparatus that is connected to a plurality of individual communication control apparatuses that each manages, for each cluster, a plurality of radio apparatuses shared by a plurality of operators, the communication control apparatus comprising:
a receiver that receives, from each individual communication control apparatus, an alteration-induced value related to an evaluation value for each operator of each radio apparatus in an own cluster under an assumption of increasing/decreasing a radio resource allocated to each operator of each radio apparatus in the own cluster;
decision processor circuitry that decides, for each cluster, a constraint condition that maximizes the alteration-induced value of each radio apparatus in all the clusters and under which a capacity of the radio resource allocated to each radio apparatus satisfies a first prescribed quantity and a calculation capacity of a radio resource allocated to each operator in an entire cluster satisfies a second prescribed quantity; and
notification processor circuitry that notifies each individual communication control apparatus that manages the cluster of the constraint condition decided for each cluster.
